(19) United States
(12) Patent Application Publication
(10) Pub. No.: US 2026/0189769 A1
(43) Pub. Date: Jul. 2, 2026

(54) Systems and methods for identity-preserving generative video enhancement

(71) Applicant: Voia Inc., Sunnyvale, CA (US)

(72) Inventors: Avner Braverman, Sunnyvale, CA (US); Haim Helman, San Jose, CA (US); Arjun Arora, Mountain View, CA (US); Noam Malali, Tel Aviv (IL); Mitch Singer, Santa Ana, CA (US); Bryan Barber, Beverly Hills, CA (US); Ryan Fleischer, Groton, MA (US)

(73) Assignee: Voia Inc., Sunnyvale, CA (US)

(21) Appl. No.: 19/544,081

(22) Filed: Feb. 19, 2026

Related U.S. Application Data
(63) Continuation-in-part of application No. 18/806,120, filed on Aug. 15, 2024.
(60) Provisional application No. 63/520,667, filed on Aug. 21, 2023.
(60) Provisional application No. 63/764,597, filed on Feb. 28, 2025.
(60) Provisional application No. 63/851,739, filed on Jul. 27, 2025.

(51) Int. Cl. H04N 21/81; G06N 3/0475; G06T 7/20; G06T 13/40; G06T 15/50; G06T 15/60

(52) U.S. Cl. CPC H04N 21/816; G06N 3/0475; G06T 7/20; G06T 13/40; G06T 15/506; G06T 15/60; G06T 2207/30241

(57) ABSTRACT

Systems and methods for enhancing a composite video sequence created by integrating a real-world object into a synthetic environment. An initial composite video sequence, which may contain visual inconsistencies, is received. Object appearance information, derived from an original source recording of the object, is also received to guide the enhancement process. A generative model processes the initial composite video, conditioned on both the initial composite's content and the object appearance information. This process generates an enhanced video sequence wherein the visual integration of the object into the environment is improved. Enhancements include corrections to lighting, color, contrast, and shadows, as well as generative stabilization of noisy camera motion and correction of viewpoint discrepancies. Critically, the process preserves the identity of the real-world object. A method for training the generative model is provided, utilizing a combined loss function that balances reconstruction accuracy with an identity loss to ensure robust identity preservation.

### CROSS REFERENCE TO RELATED APPLICATIONS

This Application is a continuation-in-part of U.S. patent application Ser. No. 18/806,120 filed on Aug. 15, 2024, which claims priority to U.S. Provisional Application No. 63/520,667, filed on Aug. 21, 2023. This Application also claims priority to U.S. Provisional Application No. 63/764,597, filed on Feb. 28, 2025, and to U.S. Provisional Application No. 63/851,739, filed on Jul. 27, 2025.

### FIELD OF THE INVENTION

This Application relates generally to the field of image and video generation.

### SUMMARY

In one embodiment, a method for generating an enhanced video sequence depicting a real-world object integrated into a synthetic environment comprises: receiving an initial composite video sequence, wherein frames of said initial composite video sequence depict representations of the real-world object integrated within corresponding depictions of the synthetic environment, and wherein said initial composite video sequence relates to an original source recording of the real-world object; receiving object appearance information characterizing visual attributes of the real-world object, said object appearance information being derived from the appearance of the real-world object within the original source recording; and processing the initial composite video sequence using a diffusion-based generative model to generate an enhanced composite video sequence. Said processing comprises guiding the diffusion-based generative model during generation of the enhanced composite video sequence utilizing information derived from both the initial composite video sequence and the received object appearance information. The generated enhanced composite video sequence exhibits visual attributes consistent with the received object appearance information, while demonstrating improved visual integration between the representations of the real-world object and the depictions of the synthetic environment compared to the initial composite video sequence.

In another embodiment, a system for generating an enhanced video sequence depicting a real-world object integrated into a synthetic environment comprises: a first input interface configured to receive an initial composite video sequence, wherein frames of said initial composite video sequence depict representations of the real-world object integrated within corresponding depictions of the synthetic environment, and wherein said initial composite video sequence relates to an original source recording of the real-world object; a second input interface configured to receive object appearance attributes characterizing the real-world object, said object appearance attributes being derived from the original source recording; a model storage configured to store a diffusion-based generative model; and at least one processor communicatively coupled to the first input interface, the second input interface, and the model storage. The at least one processor is configured to: access the diffusion-based generative model from the model storage; and process the initial composite video sequence using the accessed diffusion-based generative model to generate an enhanced composite video sequence. Said processing by the diffusion-based generative model is conditioned on both the content of the initial composite video sequence received via the first input interface and the object appearance attributes received via the second input interface to generate the enhanced composite video sequence. The generated enhanced composite video sequence, as a result of said conditioned processing, exhibits visual characteristics consistent with the received object appearance attributes, while demonstrating improved visual integration between the representations of the real-world object and the depictions of the synthetic environment compared to the initial composite video sequence. The system further comprises an output interface configured to provide the generated enhanced composite video sequence.

In yet another embodiment, a method for training a diffusion-based generative model to enhance video sequences while preserving object identity comprises: for a plurality of training steps, utilizing a training data tuple comprising (i) an initial composite frame, (ii) object appearance information derived from an original source recording, and (iii) a corresponding target enhanced frame. The method further comprises: processing, using the diffusion-based generative model, the initial composite frame to generate a predicted frame, wherein said processing is guided by the object appearance information; calculating a combined loss value based on: a reconstruction loss measuring a difference between the predicted frame and the target enhanced frame, and an identity loss measuring a difference between visual identity features of the object as depicted in the predicted frame and visual identity features derived from the object appearance information; and updating weights of the diffusion-based generative model based on the combined loss value.

### BRIEF DESCRIPTION OF THE DRAWINGS

The embodiments are herein described by way of example only, with reference to the accompanying drawings. No attempt is made to show structural details of the embodiments in more detail than is necessary for a fundamental understanding of the embodiments. In the drawings:

FIG. 1A illustrates one embodiment of a smartphone moving and changing orientation while capturing a sequence of images of various objects including a target object;

FIG. 1B illustrates one embodiment of the smartphone including a tracking sub-system operative to track said movement and changing of orientation;

FIG. 1C illustrates one embodiment of a 3D rendering sub-system and an image processing sub-system with associated memory and code components;

FIG. 2 illustrates one embodiment of a sequence of flat-surfaced 3D-renderable objects extracted respectively from the sequence of images and more specifically from the target object appearing in the sequence of images;

FIG. 3 illustrates one embodiment of a 3D model of a synthetic scene including various synthetic objects and various light sources;

FIG. 4A illustrates one embodiment of placing one instance of the flat-surfaced 3D-renderable object in the 3D model of a synthetic scene and setting a respective viewing point corresponding to a point in the path of movement translated into a matching movement in the 3D model;

FIG. 4B illustrates one embodiment of placing another instance of the flat-surfaced 3D-renderable object in the 3D model of the synthetic scene and setting a respective different viewing point corresponding to next point in the path of movement translated into the matching movement in the 3D model;

FIG. 4C illustrates one embodiment of placing yet another instance of the flat-surfaced 3D-renderable object in the 3D model of the synthetic scene and setting a respective next viewing point corresponding to following point in the path of movement translated into the matching movement in the 3D model;

FIG. 5 illustrates one embodiment of a sequence of synthetic images that are 3D-rendered from the 3D model of the synthetic scene comprising the flat-surfaced 3D-renderable objects and via the different viewing points along the translated path of movement so as to create an illusion that the target object is an integral part of the synthetic scene;

FIG. 6A illustrates one embodiment of adding light effects to the flat-surfaced 3D-renderable object using synthetic light sources in the 3D model of the synthetic scene so as to strengthen said illusion that the target object is an integral part of the synthetic scene;

FIG. 6B illustrates one embodiment of adding shadow effects to the flat-surfaced 3D-renderable object using synthetic light sources in the 3D model of the synthetic scene so as to strengthen even more said illusion that the target object is an integral part of the synthetic scene;

FIG. 6C illustrates one embodiment of adding reflection effects to the flat-surfaced 3D-renderable object using synthetic light sources and reflective surfaces in the 3D model of the synthetic scene so as to strengthen yet again said illusion that the target object is an integral part of the synthetic scene;

FIG. 7 illustrates one embodiment of a method for integrating a 2D image of a real 3D object into a synthetic 3D scene;

FIG. 8A illustrates one embodiment of defining a video-projection-area associated with a three-dimensional object appearing in a 3D scene;

FIG. 8B illustrates one embodiment of generating markings in conjunction with the main video, each marking representing an instance of the video-projection-area as it appears in the respective image of the main video;

FIG. 8C illustrates one embodiment of an external video to be later integrated into the main video, creating the illusion of the external video being projected onto the flat side of the 3D object in the main video;

FIG. 8D illustrates one embodiment of fitting images in the external video stream within boundaries of respective markings, preparing them for embedding within the main video;

FIG. 8E illustrates one embodiment of embedding adjusted images within the main video, creating the illusion of the external video being projected on the 3D object in the main video;

FIG. 9 illustrates one embodiment of a system operative to define a video-projection-area on a flat side of a three-dimensional object within a 3D scene, enabling seamless integration of external video content into the main video;

FIG. 10A illustrates one embodiment of a method for facilitating embedding of an external video stream within a main video of a certain scene;

FIG. 10B illustrates one embodiment of a method for embedding an external video stream within a main video of a certain scene so as to create an illusion of the external video being projected on a flat side of a 3D object appearing in the main video;

FIG. 11A illustrates one embodiment of a background image;

FIG. 11B illustrates one embodiment of an object to be integrated into a background image;

FIG. 11C illustrates one embodiment of a contact shadow generated for the object;

FIG. 11D illustrates one embodiment of the object integrated into a background image including the contact shadow;

FIG. 11E illustrates one embodiment of a system performing an inference process using a machine learning model to generate a final integrated image from input representations;

FIG. 11F illustrates one embodiment of a training system and associated training data pairs comprising representations with and without shadows that are utilized to train the machine learning model;

FIG. 12A illustrates one embodiment of a method for generating contact shadows;

FIG. 12B illustrates one embodiment of a method for training a machine learning model to generate contact shadows;

FIG. 13A illustrates one embodiment of an initial object representation with a texture contrast that is inconsistent with its environment;

FIG. 13B illustrates one embodiment of an enhanced object representation with a corrected texture contrast and preserved identity;

FIG. 14A illustrates one embodiment of an initial human representation whose gaze direction is inconsistent with the synthetic environment;

FIG. 14B illustrates one embodiment of an enhanced human representation with an adaptively corrected gaze direction;

FIG. 15 illustrates one embodiment of a system performing an inference process to generate an enhanced output from multiple inputs;

FIG. 16 illustrates one embodiment of a training process for the generative model utilizing input data tuples;

FIG. 17A illustrates one embodiment of a method for generating an enhanced sequence;

FIG. 17B illustrates one embodiment of a method for training the diffusion-based generative model;

FIG. 18A illustrates one embodiment of generating various masking constraints for a human object including a global silhouette mask and segmented masks distinguishing between rigid identity features and articulable regions;

FIG. 18B illustrates one embodiment of generating a masking constraint for a non-human animate object; and

FIG. 18C illustrates one embodiment of generating a masking constraint for an inanimate object demonstrating the application of spatial constraints to rigid structures.

### DETAILED DESCRIPTION

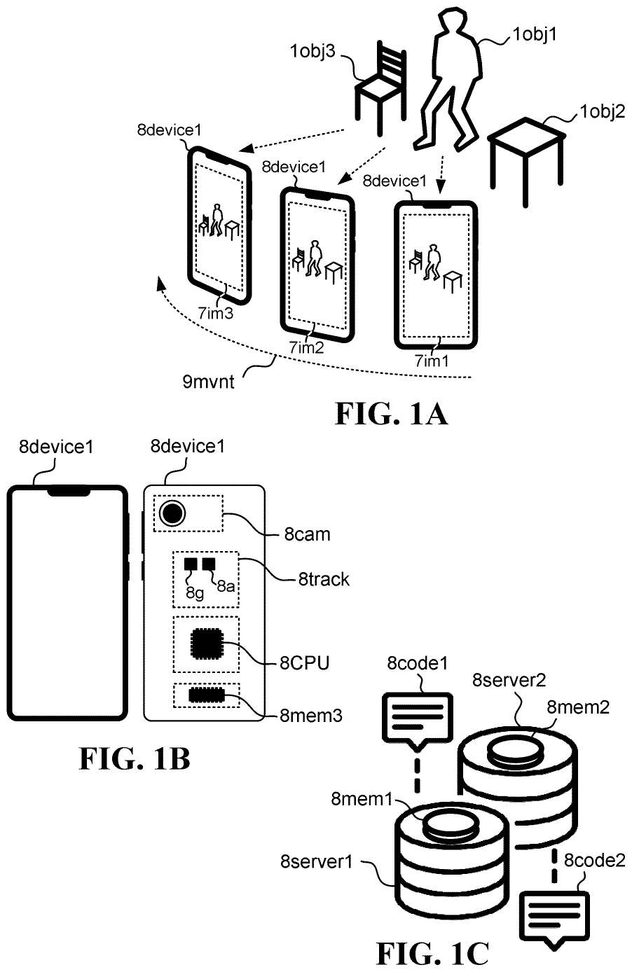

FIG. 1A illustrates one embodiment of a smartphone 8device1, or any other smart device comprising a camera, moving and changing orientation 9mvnt while capturing a sequence of images 7im1, 7im2, 7im3 of various objects 1obj including a target object 1obj1.

For example, a user walking through their living room, their smartphone in hand. As they move, their smartphone, 8device1, captures a sequence of images 7im1, 7im2, and 7im3. Each image captures a snapshot of the room from slightly different positions and angles, represented by the changing orientation 9mvnt of the phone. The room contains various objects lobj, including furniture, decorations, and a person (lobj1) who is the primary subject of an image integration process to follow.

FIG. 1B illustrates one embodiment of the smartphone 8device1 including a tracking sub-system 8track operative to track said movement and changing of orientation 9mvnt. A related camera 8cam, processor 8CPU and memory 8mem3 are also shown.

In one embodiment, the image capturing may be performed by the camera 8cam, while a sophisticated tracking sub-system 8track constantly monitors the phone's every move. This sub-system, which could be comprised of a gyroscope 8g and accelerometer 8a, precisely tracks the movement and orientation changes, 9mvnt, of the smartphone. This tracking information is crucial for understanding the camera's position and viewpoint in relation to the person, lobj1 in each frame. The smartphone's processor 8CPU and memory 8mem3 work in conjunction with the tracking sub-system, ensuring efficient data processing and storage.

FIG. 1C illustrates one embodiment of a 3D rendering sub-system 8server2 and an image processing sub-system 8server1 with respective memories 8mem2, 8mem1 and code components 8code2, 8code1.

In one embodiment, the captured images and tracking data are transmitted to a backend system. Here, an image processing sub-system, 8server1, with its memory 8mem1 and code components 8code1, including potentially sophisticated machine learning models, gets to work. It analyzes the images, expertly identifying and extracting the person, lobj1, from the background. Meanwhile, a dedicated 3D rendering sub-system 8server2 stands ready with its memory 8mem2 and code components 8code2 to receive the extracted object data and seamlessly integrate it into the final, illusion-filled video. In one embodiment, the functions of the servers, or parts thereof, are performed internally within the smartphone or a similar device 8device1.

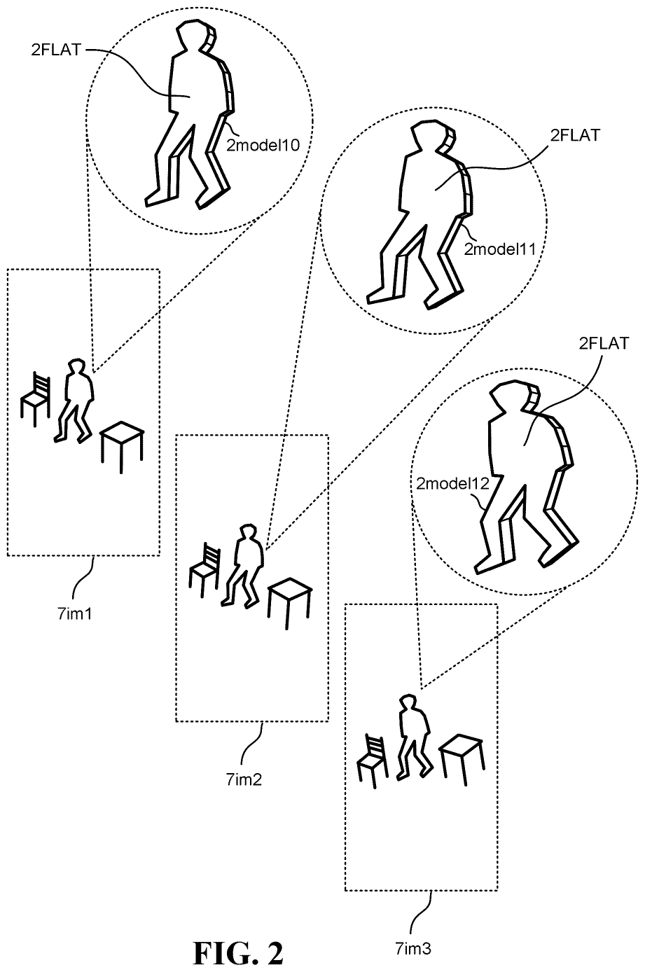

FIG. 2 illustrates one embodiment of a sequence of flat-surfaced 3D-renderable objects 2model10, 2model11, 2model12 extracted respectively from the sequence of images 7im1, 7im2, 7im3 and more specifically from the target object 1obj1 appearing in the sequence of images.

Focus now shifts to the person, lobj1, as an example. From each captured image, 7im1, 7im2, 7im3, the image processing system generates a corresponding flat-surfaced 3D-renderable object: 2model10, 2model11, and 2model12. These objects, though simple in their flatness, are the building blocks of the illusion. Each object's flat side, denoted as 2FLAT, acts as a kind of a canvas, textured with the image of the person as they appeared in the corresponding frame.

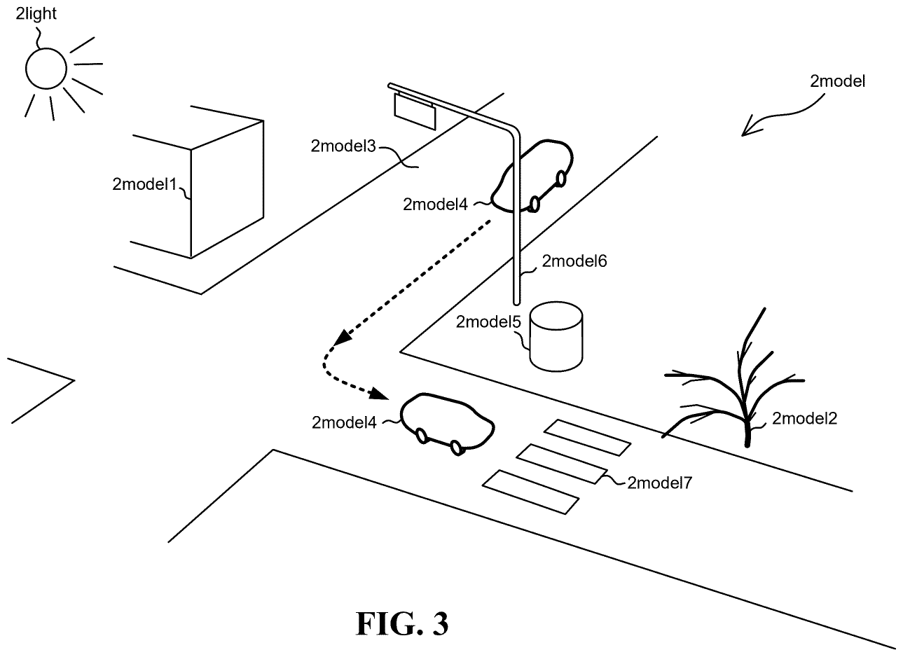

FIG. 3 illustrates one embodiment of a 3D model 2model of a synthetic scene including various synthetic objects and various light sources 2light.

The stage is set. In one embodiment, a rich, detailed 3D model 2model of a synthetic scene is prepared. It could be a bustling cityscape, a tranquil forest, or any other virtual environment. This scene is populated with various synthetic objects, for example 2model1, 2model2, 2model3, 2model4, 2model5, 2model6, and 2model7, each contributing to the immersive experience. Carefully positioned light sources 2light bathe the scene in a realistic glow, casting subtle shadows and highlights that will further enhance the illusion to come. The person 1obj1 will be integrated into this scene.

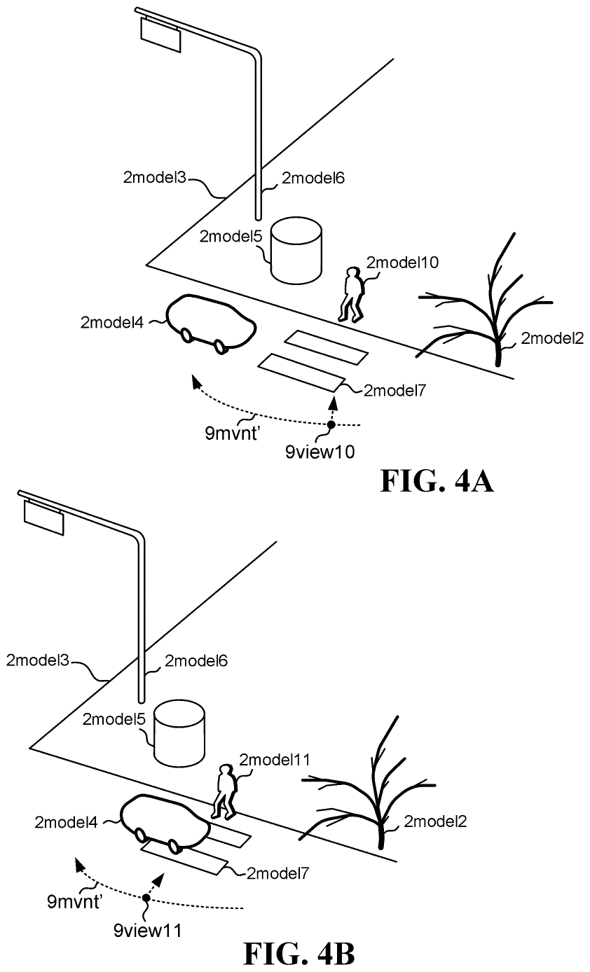

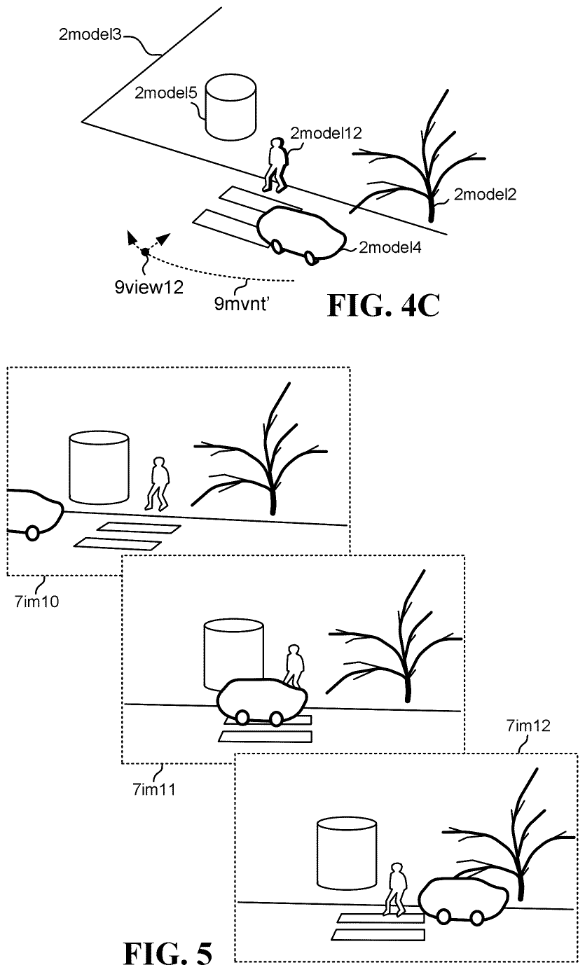

FIG. 4A illustrates one embodiment of placing one instance 2model10 of the flat-surfaced 3D-renderable object in the 3D model of a synthetic scene and setting a respective viewing point 9view10 corresponding to a point in the path of movement 9mvnt translated into a matching movement 9mvnt′ in the 3D model 2model.

FIG. 4B illustrates one embodiment of placing another instance 2model11 of the flat-surfaced 3D-renderable object in the 3D model of the synthetic scene and setting a respective different viewing point 9view11 corresponding to next point in the path of movement 9mvnt translated into the matching movement 9mvnt′ in the 3D model 2model.

FIG. 4C illustrates one embodiment of placing yet another instance 2model12 of the flat-surfaced 3D-renderable object in the 3D model of the synthetic scene and setting a respective next viewing point 9view12 corresponding to following point in the path of movement 9mvnt translated into the matching movement 9mvnt′ in the 3D model 2model.

Now, the magic begins. In one embodiment, each of the flat-surfaced 3D objects 2model10, 2model11, and 2model12, each depicting the person 1obj1 from a different viewpoint, is carefully placed and oriented within the synthetic scene 2model. Imagine these objects as virtual photographs of the person, strategically positioned to precisely match their real-world position and orientation as captured by the moving smartphone. Each flat-surfaced 3D object is associated with a corresponding viewpoint, 9view10, 9view11, 9view12, mimicking the smartphone's position and orientation 9mvnt, which has been translated into a matching movement within the 3D space, denoted as 9mvnt′.

FIG. 5 illustrates one embodiment of a sequence of synthetic images 7im10, 7im11, 7im12 that are 3D-rendered from the 3D model of the synthetic scene 2model comprising the flat-surfaced 3D-renderable objects 2model10, 2model11, 2model12 and via the different viewing points 9view10, 9view11, 9view12 along the translated path of movement 9mvnt′ so as to create an illusion that the target object 1obj1 is an integral part of the synthetic scene.

The scene is set, the virtual camera in position. In one embodiment, the 3D rendering system renders a sequence of synthetic images 7im10, 7im11, and 7im12 from the prepared 3D model. Each image is rendered from the viewpoint associated with its corresponding flat-surfaced object, following the translated path of movement 9mvnt′. When these images are played in sequence, a captivating illusion emerges: the person appears seamlessly integrated into the synthetic scene, as if they had always been there.

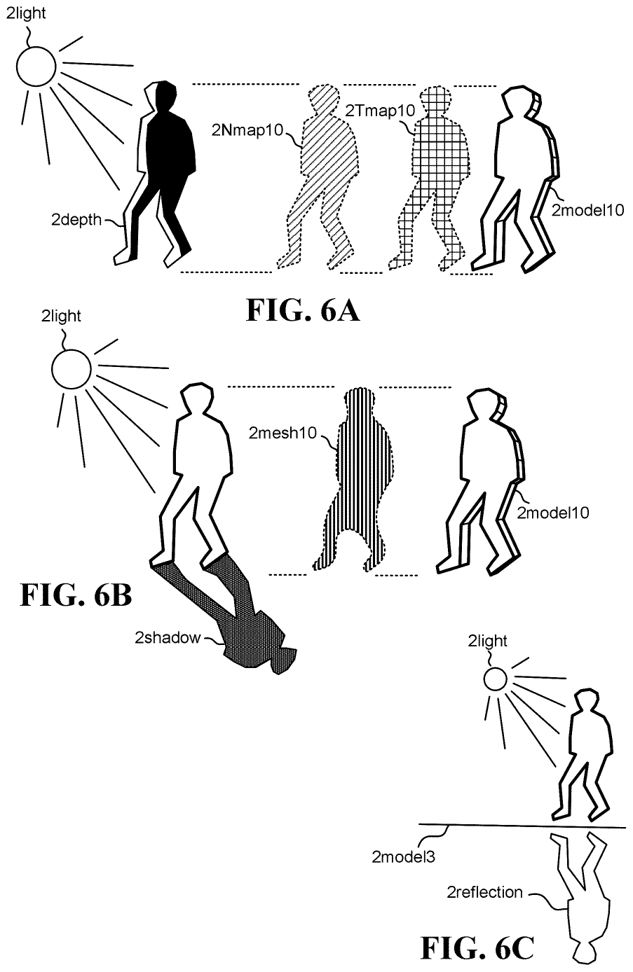

FIG. 6A illustrates one embodiment of adding light effects 2depth to the flat-surfaced 3D-renderable object 2model10 using synthetic light sources 2light in the 3D model of the synthetic scene 2model so as to strengthen said illusion that the target object 1obj1 is an integral part of the synthetic scene. A related texture map 2Tmap10 and a normals map 2Nmap10 are also shown.

FIG. 6B illustrates one embodiment of adding shadow effects 2shadow to the flat-surfaced 3D-renderable object 2model10 using synthetic light sources 2light in the 3D model of the synthetic scene 2model so as to strengthen even more said illusion that the target object 1obj1 is an integral part of the synthetic scene. A related 3D mesh 2mesh10 is also shown.

FIG. 6C illustrates one embodiment of adding reflection effects 2reflection to the flat-surfaced 3D-renderable object 2model10 using synthetic light sources 2light and reflective surfaces 2model3 in the 3D model of the synthetic scene 2model so as to strengthen yet again said illusion that the target object 1obj1 is an integral part of the synthetic scene.

To further enhance the realism and solidify the illusion, in one embodiment, the rendering system employs advanced techniques. The texture map 2Tmap10 applied to the flat surfaces is complemented by a normals map 2Nmap10, defining the surface's orientation and enabling realistic light interaction. This creates the illusion of depth 2depth, making the flat surface of the person appear convincingly three-dimensional. Additionally, the system can utilize a 3D mesh 2mesh10 to calculate and render realistic shadows 2shadow cast by the person onto the surrounding environment. Reflections 2reflection of the person on other surfaces in the scene, like a reflective surface 2model3, further add to the immersive visual experience, making the integration nearly indistinguishable from reality.

### Exemplary Scenario #1: Integrating a Parked Sports Car Into a Racing Stadium

Capture: A user walks by a parked sports car lobj1 on a regular city street and decides to capture its sleek design. They take a few steps around the car, capturing a sequence of images 7im1, 7im2, 7im3 with their smartphone 8device1. Other objects lobj in the scene might include sidewalks, streetlights, and nearby buildings. The smartphone's tracking sub-system 8track diligently records the user's movement and the phone's orientation changes 9mvnt using its internal gyroscope 8g and accelerometer 8a.

Processing: The captured images and tracking data are transmitted to the image processing server 8server1. Sophisticated algorithms (8code1), potentially powered by machine learning, identify and extract the sports car lobj1 from each image, separating it from the background. Simultaneously, the 3D rendering server 8server2 loads a vibrant 3D model 2model of a famous racing stadium, packed with grandstands, a bustling pit lane, and bathed in the bright lights (2light) typical of such a venue.

3D Object Generation: For each captured image 7im1, 7im2, 7im3, a corresponding flat-surfaced 3D object (2model10, 2model11, 2model12) is generated. The flat side 2FLAT of each object is meticulously textured with the image of the sports car, preserving its appearance from that specific angle.

Integration and Rendering: Now, the magic of illusion begins. Even though the real sports car is stationary, the tracked movement 9mvnt of the smartphone allows for a dynamic integration. The flat-surfaced objects are strategically placed within the 3D racing stadium model 2model, positioned as if the car were parked in the pit lane, ready for the race. The user's original movements 9mvnt are translated into matching movements 9mvnt′ within the virtual stadium, and virtual viewpoints 9view10, 9view11, 9view12 are set accordingly. The 3D rendering system then produces a sequence of synthetic images 7im10, 7im11, 7im12 from these viewpoints, creating an animation of the viewer “walking around” the car inside the stadium.

Enhancements: To amplify the realism, additional visual effects are employed. A normals map 2Nmap10 is applied to the flat-surfaced car objects, allowing them to interact convincingly with the stadium lights and create an illusion of depth 2depth. Shadows 2shadow of the car are cast on the pit lane floor, and reflections 2reflection gleam off its polished surface, mimicking the ambiance of the racing environment.

Result: The final rendered video transports the user and the sports car from the mundane city street to the heart of a thrilling racing stadium. The car, though originally stationary, appears as a natural part of the scene, seamlessly integrated into this exciting new environment thanks to the clever combination of image capture, tracking, and 3D rendering techniques. The illusion is complete, blurring the lines between reality and the virtual world.

### Exemplary Scenario #2: Placing a Person in a Historical Setting

Capture: Imagine a tourist visiting a historical landmark, capturing a friend lobj1 posing in front of an ancient ruin. The smartphone 8device1 captures a sequence of images 7im1, 7im2, 7im3, while the tracking sub-system 8track accurately records the phone's movements 9mvnt.

Processing: The images are processed locally in the smartphone, where the person lobj1 is extracted, aided by machine learning models 8code1 that may be utilized by the smartphone. The rendering server 8server2 prepares a 3D model 2model of the historical site, including detailed reconstructions of buildings and structures, along with accurate lighting 2light that simulates the time of day.

3D Object Generation: Flat-surfaced 3D objects 2model10, 2model11, 2model12 are created from the extracted images of the person, each textured with the corresponding pose from 7im1, 7im2, 7im3 on its flat side 2FLAT.

Integration and Rendering: Guided by the translated movement 9mvnt′ of the smartphone, the flat-surfaced objects are placed and oriented within the 3D model 2model, precisely matching the person's position and pose across the captured images. The final rendered video 7im10, 7im11, 7im12 is created from virtual viewpoints 9view10, 9view11, 9view12 that correspond to the user's original movements.

Result: The final video shows the tourist's friend seamlessly integrated into the historical setting. They appear as if they were truly present at the landmark, convincingly blended into the scene thanks to the accurate tracking and 3D rendering process.

### Exemplary Scenario #3: Adding a Virtual Coffee Cup to a Tabletop Scene

Capture: A user sets a coffee cup lobj1 on their desk and captures a few images 7im1, 7im2, 7im3 with their smartphone 8device1, focusing on the cup as the main subject. The tracking sub-system 8track records the phone's movements 9mvnt.

Processing: The image processing server 8server1 isolates the coffee cup lobj1 from the background clutter lobj (papers, pens, etc.) using machine learning algorithms 8code1. The rendering server 8server2 loads a simple 3D model 2model of a wooden tabletop lit by a warm lamp (2light).

3D Object Generation: Flat-surfaced 3D objects 2model10, 2model11, 2model12 are generated, textured with the captured images of the coffee cup on their 2FLAT sides.

Integration and Rendering: The coffee cup objects are positioned on the tabletop within the 3D scene 2model, matching the real cup's placement across the images. The final video is rendered from viewpoints 9view10, 9view11, 9view12 that mimic the smartphone's original movement, creating a realistic animation of the cup being set down.

Result: The final rendered video displays a simple yet convincing illusion. The real coffee cup appears to seamlessly materialize on the virtual tabletop, demonstrating how the invention can be used to integrate even everyday objects into synthetic environments for various creative or illustrative purposes.

One embodiment is a system operative to integrate a sequence of two-dimensional (2D) images of a real three-dimensional (3D) object into a synthetic 3D scene, comprising: an image capturing sub-system 8cam (FIG. 1B) configured to generate a sequence of images 7im1, 7im2, 7im3 (FIG. 1B) of a real object 1obj1 (FIG. 1A) over a certain period and to extract at least one type of spatial information associated with the real object; a tracking sub-system 8track (FIG. 1B) configured to track movement and orientation 9mvnt (FIG. 1A) of the image capturing sub-system 8cam during said certain period; a 3D rendering sub-system 8server2 (FIG. 1C) comprising a storage space 8mem2 operative to store a 3D model 2model (FIG. 3) of a synthetic scene; and an image processing sub-system 8server1 (FIG. 1C) configured to generate, per each of the images 7im1, 7im2, 7im3 in said sequence, a respective 3D-renderable object 2model10, 2model11, 2model12 (FIG. 2) having a flat side 2FLAT that is shaped and texture-mapped 2Tmap10 (FIG. 6A) according to the respective image 7im1, 7im2, 7im3 of the real object 1obj1, thereby creating a sequence of 3D-renderable objects 2model10, 2model11, 2model12 that appear as the sequence of images of the real object 1obj1 when viewed from a viewpoint that is perpendicular to said flat side 2FLAT.

In one embodiment, the system is configured to utilize the spatial information, together with said movement and orientation tracked 9mvnt, in order to: derive a sequence of virtual viewpoints 9view10, 9view11, 9view12 (FIG. 4A, FIG. 4B, FIG. 4C) that mimic 9mvnt′ (FIG. 4A, FIG. 4B, FIG. 4C) said movement and orientation tracked 9mvnt; place and orient, in conjunction with said storage space 8mem2, the sequence of 3D-renderable objects 2model10, 2model11, 2model12 (FIG. 4A, FIG. 4B, FIG. 4C) in the 3D model 2model of the synthetic scene so as to cause the shaped and texture-mapped flat side 2FLAT of each of the 3D-renderable objects 2model10, 2model11, 2model12 to face a respective one of the virtual viewpoints 9view10, 9view11, 9view12; and render a sequence of synthetic images 7im10, 7im11, 7im12 (FIG. 5), using the 3D rendering sub-system 8server2 and in conjunction with the 3D model 2model of the synthetic scene now including the sequence of 3D-renderable objects 2model10, 2model11, 2model12, from a set of rendering viewpoints that matches the sequence of virtual viewpoints 9view10, 9view11, 9view12 mimicking 9mvnt′ said movement and orientation tracked 9mvnt; thereby creating a visual illusion that the real object 1obj1 is located in the synthetic scene.

In one embodiment, said 3D-renderable object 2model10, 2model11, 2model12 is a two-dimensional (2D) surface constituting a 2D sprite of the real object 1obj1.

In one embodiment, the image processing sub-system 8server1 is further configured to generate and place a 2D normals map 2Nmap10 (FIG. 6A) upon the 2D sprite 2model10, 2model11, 2model12, in which said 2D normals map is operative to inform the 3D rendering sub-system 8server2 regarding which 3D direction each point in the texture map 2Tmap10 of the 2D sprite 2model10, 2model11, 2model12 is facing; and the 3D rendering sub-system 8server2 is further configured to use said 2D normals map 2Tmap10, in conjunction with said rendering of said sequence of synthetic images 7im10, 7im11, 7im12, to generate an illusion of depth using lighting effects 2depth (FIG. 6A).

In one embodiment, the image processing sub-system 8server1 comprises a respective storage space 8mem1; and said 2D normals map 2Nmap10 generation is done in the image processing sub-system 8server1 using a machine learning model 8code1 that is stored in said respective storage space 8mem1 and that is operative to receive the texture map 2Tmap10 of the 2D sprite 2model10, 2model11, 2model12 and extrapolate said normals 2Nmap10 maps from said texture map received.

In one embodiment, said lighting effects are associated with lighting sources 2light (FIG. 3, FIG. 6A) embedded in the 3D model 2model of the synthetic scene, in which said lighting sources are operative to interact with the normals maps 2Nmap10 of the 2D sprite 2model10, 2model11, 2model12, in conjunction with said rendering of said sequence of synthetic images 7im10, 7im11, 7im12, to facilitate said illusion of depth 2depth and to enhance said visual illusion that the real object 1obj1 is located in the synthetic scene.

In one embodiment, the image processing sub-system 8server1 is further configured to generate and place a shadow mesh 2mesh10 (FIG. 6B) matching an expected 3D extrapolation of the 2D sprite 2model10, 2model11, 2model12, in which said shadow mesh is operative to inform the 3D rendering sub-system 8server2 regarding a shadow that the 2D sprite would have casted as a 3D body; and the 3D rendering sub-system 8server2 is further configured to use said shadow mesh 2mesh10, in conjunction with said rendering of said sequence of synthetic images 7im10, 7im11, 7im12, to generate an illusion of a shadow 2shadow (FIG. 6B) casted by the real object 1obj1.

In one embodiment, the image processing sub-system 8server1 comprises a respective storage space 8mem1; and said 3D extrapolation is done in the image processing sub-system 8server1 using a machine learning model 8code1 that is stored in said respective storage space and that is operative to receive at least the texture map 2Tmap10 of the 2D sprite 2model10, 2model11, 2model12 and extrapolate said shadow mesh 2mesh10 from said texture map received.

In one embodiment, said 3D model 2model of the synthetic scene comprises various other 3D elements, in which at least one of the other 3D elements 2model3 is a reflective surface such as a body of water and/or a flat polished surface such as a wet road, and in which an image of the 2D sprite 2model10, 2model11, 2model12 is reflected 2reflection (FIG. 6C) from the reflective surface 2model3 in conjunction with said rendering of said sequence of synthetic images 7im10, 7im11, 7im12 and further in conjunction with lighting sources 2light embedded in the 3D model 2model of the synthetic scene, thereby enhancing said visual illusion that the real object 1obj1 is located in the synthetic scene.

In one embodiment, said 3D-renderable object 2model10, 2model11, 2model12 is a 3D object having a flat side 2FLAT.

In one embodiment, the image processing sub-system 8server1 comprises a respective storage space 8mem1; and as part of said generation of the 3D-renderable objects 2model10, 2model11, 2model12 having the flat sides 2FLAT that are shaped and texture-mapped 2Tmap10 according to the images 7im1, 7im2, 7im3 of the real object 1obj1, the image processing sub-system is further configured to: detect boundaries of the object 1obj1 in the images 7im1, 7im2, 7im3 using a machine learning model 8code1 stored in said respective storage space 8mem1; and remove, in conjunction with said boundaries detected, a background 1obj2, 1obj3 (FIG. 1A) appearing in the images 7im1, 7im2, 7im3, thereby being left with a representation of the object itself 1obj1 that is operative to constitute the flat sides 2FLAT that are shaped and texture-mapped 2Tmap10 according to the object itself 1obj1.

In one embodiment, said 3D model 2model of the synthetic scene comprises various other 3D items 2model4, in which at least one of the other 3D items 2model4 partially blocks, in a visual sense, at least some of the 3D-renderable objects 2model11 (FIG. 4B) in the 3D model 2model when viewed from said virtual viewpoints 9view11, and in which such partial blockage is inherently translated, during said rendering sequence, to synthetic images 7im11 of the 3D-renderable objects 2model11 that are partially obscured by said at least one item 2model4.

In one embodiment, said at least one type of spatial information associated with the real object 1obj1 comprises at least one of: (i) distance from the image capturing sub-system 8cam and (ii) height above ground.

In one embodiment, said real object 1obj1 comprises at least one of: (i) a person, (ii) a group of persons, (iii) animals, and (iv) inanimate objects such as furniture and vehicles.

In one embodiment, said image capturing sub-system 8cam comprises a camera of a smartphone 8device1 (FIG. 1A, FIG. 1B).

In one embodiment, said tracking sub-system 8track comprises at least part of an inertial positioning system integrated in the smartphone 8device1.

In one embodiment, said inertial positioning system comprises at least one of: (i) at least one accelerometer 8a (FIG. 1B) and (ii) a gyroscope 8g (FIG. 1B).

In one embodiment, said inertial positioning system comprises at least a visual simultaneous localization and mapping (VSLAM) sub-system 8CPU+8mem3+8track (FIG. 1B).

In one embodiment, said image capturing sub-system 8cam further comprises a light detection and ranging (LIDAR) sensor integrated in the smartphone 8device1 and operative to facilitated said extraction of the at least one type of spatial information.

In one embodiment, said 3D rendering sub-system 8server2 is a rendering server communicatively connected with said smartphone 8device1.

In one embodiment, said image processing sub-system 8server1 is an image processing server communicatively connected with said smartphone 8device1.

In one embodiment, said image processing sub-system 8server1 is a part of a processing unit 8CPU integrated in the smartphone 8device1 and comprising at least one of: (i) a central processing unit (CPU), (ii) a graphics processing unit (GPU), and (iii) an AI processing engine.

In one embodiment, the tracking sub-system comprises a visual simultaneous localization and mapping (VSLAM) server 8verver1 communicatively connected with said smartphone 8device1.

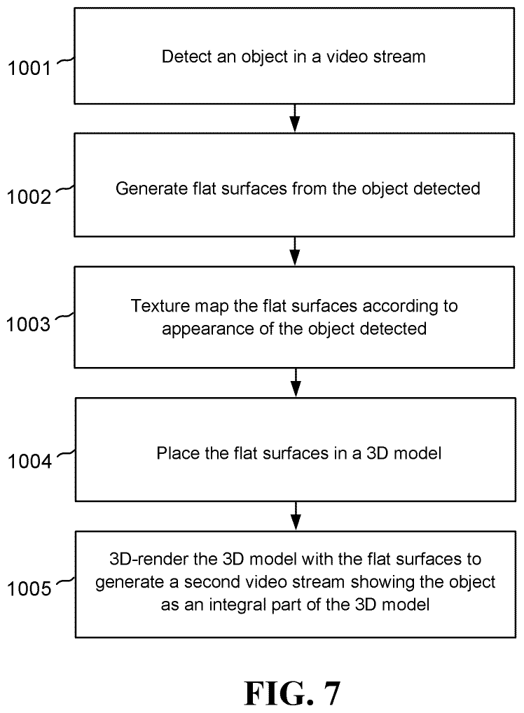

FIG. 7 illustrates one embodiment of a method for integrating a two-dimensional (2D) image of a real three-dimensional (3D) object into a synthetic 3D scene. The method includes: in step 1001, detecting, in a first video stream 7im1, 7im2, 7im3, an object 1obj1 appearing therewith. In step 1002, generating a sequence of 3D-renderable flat surfaces 2model10, 2model11, 2model12, in which each of the surfaces has a contour that matches boundaries of the object 1obj1 as appearing in the video stream 7im1, 7im2, 7im3. In step 1003, texture mapping 2Tmap10 the 3D-renderable flat surfaces 2model10, 2model11, 2model12 according to the appearance of the object 1obj1 in the video stream 7im1, 7im2, 7im3. In step 1004, placing and orienting the texture-mapped 3D-renderable flat surfaces 2model10, 2model11, 2model12 in a 3D model 2model of a synthetic scene. In step 1005, 3D-rendering the 3D model 2model of the synthetic scene that includes the texture-mapped 3D-renderable flat surfaces 2model10, 2model11, 2model12, thereby generating a second video 7im10, 7im11, 7im12 showing the object 1obj1 as an integral part of the synthetic scene.

Understanding “Flat Surface” in the Context of the Invention.

The term “flat surface,” as used in this invention, refers to the primary 3D-renderable object that represents the real-world object within the synthetic scene. While the term “flat” might initially suggest a perfectly planar surface, it encompasses a broader concept in this context.

Here's a breakdown of what “flat surface” signifies in this invention:

Essentially 2D: Despite being rendered in a 3D environment, the core object remains fundamentally two-dimensional. It's like a sheet of paper or a canvas, possessing width and height but minimal or no depth. It primarily serves as a display surface for the texture mapped from the captured image of the real-world object.

Degrees of Flatness: The “flatness” can vary:

Completely Flat (Canvas-like): The surface can be perfectly planar, much like a canvas onto which an image is projected. This works well for all 3D objects.

Slightly Bent (Topography-Aware): To enhance realism, the surface can be slightly bent or curved to reflect the basic topography of the captured object. This means it can follow the general contours of the object without being a fully realized 3D model. For instance:

Person: The flat surface representing a person might be slightly bent to follow the curvature of their body, but it wouldn't have the full volume and detail of a complete 3D human model. It's still essentially a “flat” representation with subtle adjustments.

Car: The flat surface representing a car could be gently curved to follow the roofline and side panels, capturing the basic shape without including the full depth of the vehicle's interior or engine.

Distinction from 3D Objects: The key distinction is that these “flat surfaces” are not intended to be complete, volumetric 3D models of the objects. They don't have the internal structure, details, or complexity of a true 3D object. Instead, they are cleverly crafted 2D representations projected into the 3D space, optimized for creating a convincing illusion when viewed from specific angles and combined with tracking data.

By using these simplified “flat surfaces” instead of complex 3D models, the invention achieves a balance between realism and computational efficiency. The illusion of integration is achieved by leveraging accurate tracking data and rendering the surfaces from specific viewpoints, making the flat representations appear convincingly three-dimensional to the viewer.

It is important to clarify that the term “flat surface,” as used in this invention, refers primarily to the visible side of the 3D-renderable object, the side that faces the virtual camera during the rendering process. The opposite side, or “back” of the flat surface, is by definition hidden from view in the final rendered video and therefore can be of any arbitrary shape without affecting the visual result.

Tracking with Gyroscopes and Accelerometers: General Principle: Gyroscopes and accelerometers are inertial sensors commonly used for motion tracking. They work in tandem to provide information about an object's orientation and movement in space. Gyroscope: Measures angular velocity, which is the rate of rotation around an axis. It helps determine how the object is turning or tilting. Accelerometer: Measures linear acceleration, which is the rate of change in velocity in a straight line. It detects movement in any direction, including gravity.

Tracking Applications: By combining data from both sensors, we can: Determine Orientation: The gyroscope provides data on rotations, allowing us to calculate the object's current tilt and heading. Estimate Position: Integrating acceleration data over time can provide an estimate of the object's displacement (change in position).

Limitations: Drift: Gyroscope readings tend to drift over time due to small errors accumulating. Integration Error: Errors in acceleration readings can compound during integration, leading to inaccurate position estimates, especially over longer durations.

Specific Application in the Invention: In this invention, the gyroscope and accelerometer in the smartphone 8track (FIG. 1B) track the device's movement (9mvnt FIG. 1A) as the user captures images of the target object. This tracking data is crucial for: Determining Camera Pose: By knowing the smartphone's orientation and position, we can accurately determine the camera's viewpoint for each captured image. Positioning 3D Objects: This tracking information is used to precisely position and orient the flat-surfaced 3D objects (2model10, 2model11, 2model12—FIG. 2) within the synthetic scene (2model—FIG. 3). Creating Viewpoints for Rendering: The tracked camera movement is translated into a corresponding movement (9mvnt′—FIG. 4) within the 3D model, defining the virtual viewpoints (9view10, 9view11, 9view12—FIG. 4) from which the final video is rendered.

Tracking with SLAM (Simultaneous Localization and Mapping): General Principle: SLAM is a more advanced technique that combines sensor data (often from cameras or depth sensors) with algorithms to simultaneously: Localization: Determine the sensor's position within an unknown environment. Mapping: Build a map of the surrounding environment. Key Features: Feature Recognition: SLAM algorithms identify distinctive features in the environment and track their positions over time. Loop Closure: When the sensor revisits a previously mapped area, the algorithm recognizes the location and corrects for accumulated errors, reducing drift.

Specific Application in the Invention: A visual SLAM system 8CPU+8mem3+8track (FIG. 1B) could be implemented in the smartphone to enhance tracking accuracy. The camera 8cam would capture visual information about the environment, and the SLAM algorithms would process this data along with readings from the gyroscope 8gand accelerometer 8a. This would result in a more robust and accurate estimation of the smartphone's movement (9mvnt—FIG. 1A).

Combining Inertial Sensors and SLAM: Combining inertial sensors (gyroscope and accelerometer) with SLAM offers significant benefits for tracking accuracy: Complementary Strengths: Inertial sensors provide high-frequency motion data, while SLAM offers absolute position information and drift correction. Sensor Fusion: Algorithms can fuse data from both sources to produce a more accurate and reliable estimate of the device's movement. Reduced Drift: SLAM's loop closure capabilities help correct for the inherent drift in inertial sensor readings. In the context of the invention, combining these tracking methods results in a highly precise understanding of the user's movement during image capture. This allows for a more convincing integration of the real-world object into the synthetic scene, as the flat-surfaced 3D objects can be positioned and rendered with greater fidelity, enhancing the overall illusion.

Clarification Regarding the Nature of the “Illusion”: The invention aims to create a visual illusion that convincingly integrates a real-world object into a synthetic 3D scene. It's important to clarify that this illusion is perspective-dependent. It relies on presenting the rendered images from specific viewpoints that match the original camera positions during capture. When viewed from these intended viewpoints, the integration appears seamless and realistic. However, if viewed from other angles or perspectives, the illusion may be broken, revealing the flat nature of the 3D-renderable objects. This perspective-dependent illusion is analogous to how a forced perspective trick in photography might appear convincing from one angle but reveal the artifice from a different viewpoint. The invention leverages this principle to achieve compelling results within the constraints of efficient rendering and computational resources.

Clarification Regarding Potential Applications: The invention's core functionality, integrating a real-world object into a synthetic scene, can be applied to a wide range of scenarios and industries. Some potential applications include: Augmented Reality (AR): Enhance AR experiences by seamlessly placing real-world objects captured by users into virtual environments. Virtual Advertising: Integrate real products or advertisements into virtual scenes, creating more immersive and engaging marketing experiences. Film and Video Production: Simplify the process of adding real objects into computer-generated imagery (CGI) environments for film and video production. Training and Simulation: Create realistic training simulations by integrating captured objects into virtual environments, providing a more immersive learning experience. Gaming and Entertainment: Enhance games and interactive experiences by allowing players to seamlessly bring real-world objects into the virtual world. This list is not exhaustive, and the invention's versatility allows for further exploration and adaptation to various creative and practical uses.

Clarification Regarding Object Selection and Extraction: The invention focuses on integrating a specific target object (lobj1—FIG. 1A) into the synthetic scene. The selection of this target object, as well as its extraction from the captured images, can be achieved through various methods: Manual Selection: The user could manually designate the target object within the captured images. Automated Object Detection: Computer vision algorithms, potentially powered by machine learning, could be used to automatically detect and segment the target object based on its characteristics (shape, color, texture, etc.). Hybrid Approach: A combination of manual input and automated detection could be employed, allowing the user to refine or correct automated selections. The choice of method will depend on the specific application, the complexity of the scene, and the desired level of user interaction.

Benefits Relative to Complete 3D Object Extraction: The invention's approach, using flat-surfaced 3D-renderable objects instead of complete 3D models, offers several advantages compared to traditional methods of 3D object extraction and integration: Computational Efficiency: Creating, manipulating, and rendering flat surfaces is significantly less computationally demanding than working with complex 3D models. This makes the process faster and more efficient, particularly important for real-time applications or resource-constrained devices. Simplified Processing: The algorithms for object extraction, texture mapping, and placement are simpler for flat surfaces, requiring less processing power and memory. Ease of Integration: Placing and orienting flat surfaces within a 3D scene is easier and more flexible than integrating complex 3D objects, especially when dealing with dynamic scenes or moving objects. Reduced Data Requirements: The data required to represent a flat surface is significantly less than a full 3D model, reducing storage and transmission needs. While full 3D object extraction and integration can provide good levels of realism and interactivity, the invention's approach achieves a compelling level of visual fidelity while being more efficient and practical for many applications. It prioritizes creating a convincing illusion from specific viewpoints, striking a balance between visual quality and computational demands.

Real-Time Processing on a Smartphone: In one embodiment, the entire process, from capture to rendering, can potentially be performed in real-time directly on the user's smartphone, depending on the device's processing capabilities and the complexity of the scene: Capture: The smartphone's camera 8cam (FIG. 1B) captures a stream of images. Tracking: The onboard tracking sub-system 8track (FIG. 1B), utilizing the gyroscope 8g and accelerometer 8a (and potentially aided by visual SLAM), provides real-time data on the phone's movement and orientation. Object Extraction: On-device machine learning models 8code1 (FIG. 1C), optimized for mobile processing, could be used to rapidly identify and extract the target object from each frame. Flat Surface Generation: The extracted object is quickly transformed into a flat-surfaced 3D representation, with the texture mapped from the captured image. Placement and Rendering: Leveraging the tracking data, the flat surfaces are positioned and oriented within a pre-loaded or dynamically generated 3D scene. A mobile-optimized rendering engine renders the scene from the corresponding viewpoints, creating the integrated view in real-time. This real-time processing on a smartphone unlocks a range of possibilities for immersive and interactive applications. Users could seamlessly integrate real-world objects into AR experiences, games, or virtual environments, creating captivating and personalized interactions without reliance on external servers or cloud processing.

Selfie Integration: From Post-Processed Video to Real-Time Dynamic Backgrounds. Here are example scenarios showcasing the use of “selfie” shots captured by the front camera for both post-processed video and real-time integration:

Scenario A: Post-Processed Selfie Video in a Fantasy Landscape: Capture: A user takes a short video selfie using their smartphone's front camera 8cam (FIG. 1B). They move around slightly, perhaps striking different poses, while the tracking sub-system 8track captures their movements 9mvnt using the gyroscope 8g and accelerometer 8a. Processing: The captured video is uploaded to an app or service that utilizes the invention's principles. The image processing server 8server1 extracts the user (lobj1) from each frame of the video, separating them from the background. The rendering server 8server2 loads a breathtaking 3D model 2model of a fantastical landscape—maybe a lush forest with glowing mushrooms or a majestic mountain range under a starry sky. 3D Object Generation & Integration: For each frame, a flat-surfaced 3D object (2model10, 2model11, 2model12—FIG. 2) is generated, textured with the extracted image of the user. These objects are then placed and oriented within the fantasy landscape 2model, mimicking the user's tracked movements and poses. The original camera movements are translated to corresponding viewpoints 9view10, 9view11, 9view12 within the 3D scene. Rendering and Enhancements: The final video is rendered, showing the user seamlessly integrated into the fantasy environment. Lighting effects 2depth, shadows 2shadow, and reflections 2reflection (potentially using elements like reflective pools of water 2model3) enhance the realism, making it appear as if the user were truly present in this magical world.

Scenario B: Real-Time Dynamic Backgrounds for Video Calls: Capture: Imagine a user initiating a video call. Their smartphone's front camera 8cam continuously captures their image, while the tracking sub-system 8track constantly monitors their movements 9mvnt. Real-Time Processing: The smartphone utilizes a mobile-optimized version of the invention's system. On-device machine learning models 8code1 (FIG. 1C) rapidly extract the user lobj1 from the camera feed, separating them from their real background. Dynamic Background Rendering: Instead of a static picture, the user can select a dynamic 3D scene 2model as their background. It could be a calming beach with swaying palm trees and gentle waves, or a futuristic cityscape with flying vehicles and a vibrant skyline. Seamless Integration: For each frame, a flat-surfaced 3D object is dynamically generated, textured with the user's extracted image. It's placed and oriented within the selected 3D scene, matching the user's movements (e.g., rotation, moving/walking, holding hand movements) tracked in real-time. The scene is rendered from a viewpoint directly facing the user, creating a continuous, real-time composite video feed. Result: During the video call, the user appears seamlessly integrated into the dynamic 3D background, replacing their actual surroundings. They could be discussing business from a virtual office overlooking a bustling city, or catching up with friends from a relaxing beach, enhancing the video call experience with personalized and immersive environments.

These examples illustrate the versatility of the invention, showcasing its potential to transform both post-processed videos and real-time applications like video calls, creating more engaging and immersive experiences for users.

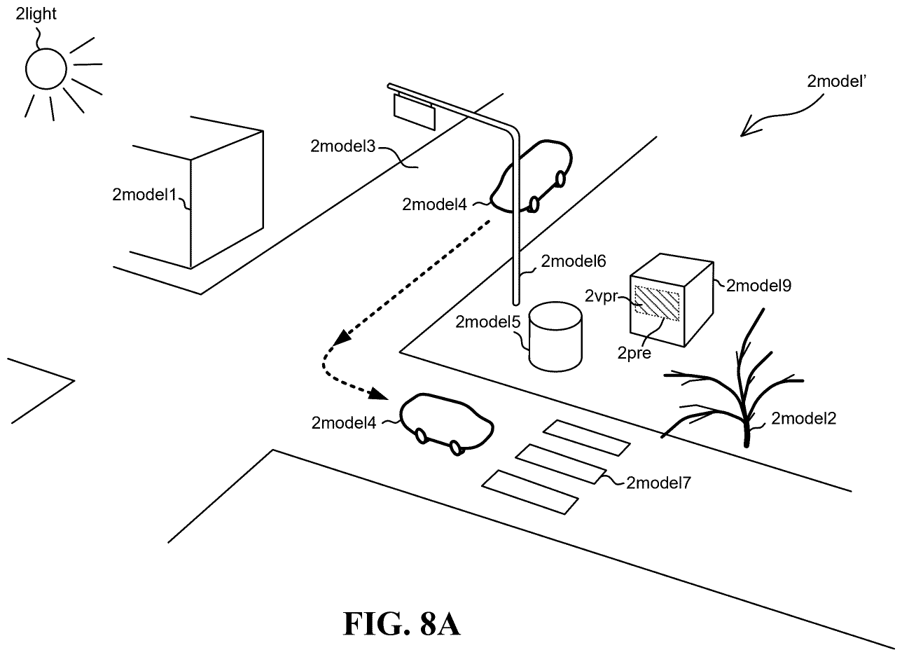

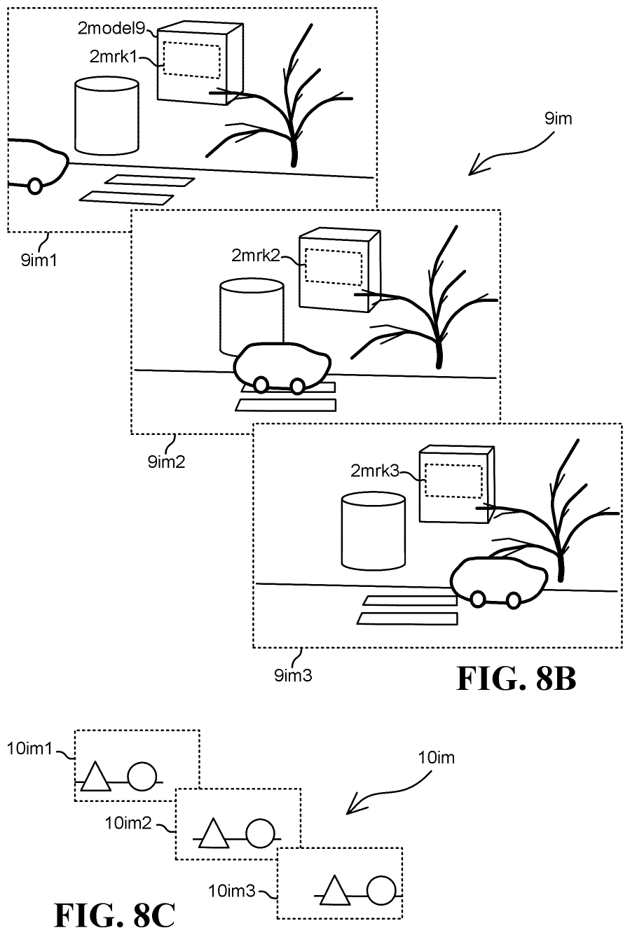

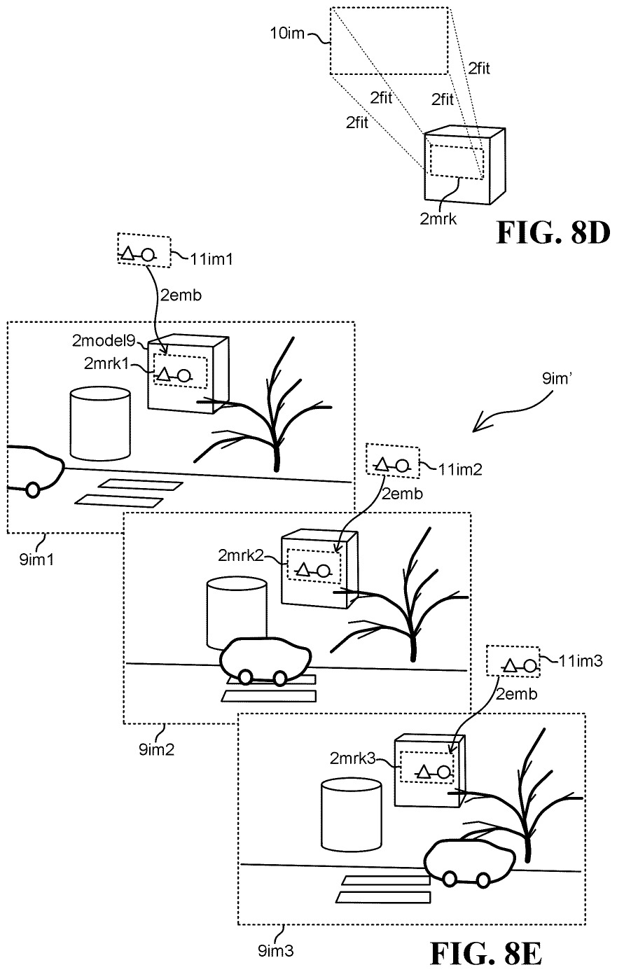

FIG. 8A illustrates one embodiment of defining a video-projection-area 2vpr associated with a three-dimensional object 2model9 within a 3D scene 2model′. The video-projection-area 2vpr is a designated region on a flat side of the three-dimensional object 2model9 within the 3D scene. The positioning of this video-projection-area 2vpr enables the future embedding of an external video stream, creating the illusion that the external video is being projected onto the designated flat side of the three-dimensional object 2model9. This strategic arrangement seamlessly integrates the external video stream with the main video, enhancing the viewer's experience and fostering an immersive visual effect. In this process, a sequence of pre-markings 2pre is generated on the flat side of the three-dimensional object 2model9 in 3D space. These pre-markings 2pre establish reference points, ensuring meticulous alignment with the geometry of the object. Ultimately, these reference points contribute to the precise projection of the external video onto the designated video-projection-area 2vpr, augmenting the realism and impact of the visual presentation.

In various outdoor scenarios, three-dimensional objects 2model9 featuring flat sides can serve as versatile canvases for video projection. For instance, a prominent street billboard could dynamically display video advertisements, a park kiosk might offer interactive maps by projecting content onto its flat panel, and outdoor stages with LED screens could create captivating visual effects during performances. Additionally, public art installations could use their flat surfaces to showcase video art, while building facades could transform into dynamic displays, exhibiting advertisements or artistic content to engage viewers. By defining designated video-projection-areas 2vpr in conjunction with these objects'flat sides, these outdoor environments can be enhanced with captivating and immersive video projection experiences when rendered into a displayable video.

FIG. 8B illustrates one embodiment of generating markings 2mrk1, 2mrk2, 2mrk3 in conjunction with the main video 9im, where each marking represents an instance of the video-projection-area 2vpr as it appears in the respective image 9im1, 9im2, 9im3 of the main video that may be rendered from the 3D scene 2model′. In this embodiment, a sequence of images forming the main video 9im1, 9im2, 9im3 of a certain scene is associated with the three-dimensional object 2model9 and its designated video-projection-area 2vpr. Within each image 9im1, 9im2, 9im3, specific markings 2mrk1, 2mrk2, 2mrk3 are generated, aligning with instances of the video-projection-area 2vpr on the three-dimensional object 2model9. These markings 2mrk1, 2mrk2, 2mrk3 serve as visual cues, enabling accurate tracking and alignment of the external video stream for future embedding. The generation of these markings 2mrk1, 2mrk2, 2mrk3 in conjunction with the main video 9im paves the way for seamless integration of an external video and the creation of an immersive visual effect that appears as though the external video is being projected onto the flat side of the three-dimensional object 2model9 within the main video 9im.

In one embodiment, during the process of transforming the 3D pre-markings 2pre into 2D markings 2mrk, each pre-marking 2pre is mapped onto its corresponding image in the main video 9im1, 9im2, 9im3 using geometric transformation techniques. These techniques involve accurately determining the two-dimensional location of each pre-marking 2pre on the flat side of the three-dimensional object 2model9 as it appears in the 3D space. The geometric shape of the markings 2mrk1, 2mrk2, 2mrk3 depends on the perspective of the viewing point that was used in conjunction with rendering the 3D scene into the main video 9im. By appropriately projecting these pre-markings 2pre onto the 2D space of the main video images 9im1, 9im2, 9im3, the sequence of 3D reference points is effectively transformed into the sequence of 2D markings 2mrk1, 2mrk2, 2mrk3. This transformation ensures that the markings align precisely with the instances of the video-projection-area 2vpr within the images of the main video 9im1, 9im2, 9im3, ultimately contributing to the seamless illusion of external video projection.

For instance, a scenario in considered where the 3D scene is rendered into the main video 9im, and during this rendering process, the pre-markings 2pre “naturally” translate into the 2D markings 2mrk1, 2mrk2, 2mrk3. Let's say that specific colors are assigned to the pre-markings 2pre on the flat side of the three-dimensional object 2model9. These colors serve as visual indicators that align with the designated video-projection-area 2vpr in the 3D scene. As the rendering process transforms the 3D scene into the main video 9im, these colored pre-markings 2pre seamlessly transition into the 2D markings 2mrk1, 2mrk2, 2mrk3. Alternatively, non-visual metadata, such as specific data attributes associated with the pre-markings 2pre, can be employed to locate these reference points in the 2D space of the main video. This metadata ensures accurate placement of the 2D markings 2mrk1, 2mrk2, 2mrk3, maintaining alignment with the instances of the video-projection-area 2vpr within the main video 9im1, 9im2, 9im3, thereby contributing to the compelling illusion of external video projection.

FIG. 8C illustrates one embodiment of an external video stream 10im to be integrated within the main video 9im. In this context, the external video 10im comprises a sequence of images 10im1, 10im2, 10im3 that is intended to be seamlessly embedded within the main video 9im, creating a harmonious visual experience. The external video 10im can encompass a variety of content types, such as advertisement videos, music videos, news clips, or tutorial videos, catering to diverse viewer preferences. By associating the external video 10im with the main video 9im and aligning it with the sequence of markings 2mrk1, 2mrk2, 2mrk3, an illusion is generated, giving the impression that the external video 10im is being projected onto the flat side of the three-dimensional object 2model9. Through this integration, the main video 9im becomes a canvas for the external video's immersive projection, enhancing the overall visual impact of the scene.

FIG. 8D illustrates one embodiment of fitting images in the external video stream within boundaries of respective markings, preparing them for embedding within the main video. In this embodiment, the process of fitting a sequence of images 10im1, 10im2, 10im3 from the external video 10im is executed meticulously. The purpose of this fitting is to ensure that the external video's content aligns seamlessly with the designated video-projection-area 2vpr on the flat side of the three-dimensional object 2model9, creating a visual illusion of projection. Each image in the sequence undergoes reshaping to harmoniously integrate with the main video 9im, preserving the illusion that the external video 10im is being projected onto the three-dimensional object 2model9. As a result of this meticulous fitting process, the images 10im1, 10im2, 10im3 are positioned within the confines of the respective markings 2mrk1, 2mrk2, 2mrk3 in the main video 9im, thereby laying the foundation for the subsequent embedding process. The alignment of the external video's images with the designated video-projection-area and markings creates a seamless transition that enhances the immersive experience for viewers.

During the rendering process of the three-dimensional scene into the main video, the appearance of the video-projection-area 2vpr within the main video is influenced by the chosen viewing angle used in the rendering. This perspective-dependent transformation introduces a dynamic dimension to the integration process, requiring various types of fittings to maintain the illusion of seamless projection onto the flat side of the three-dimensional object 2model9. Depending on the viewing angle, different types of adjustments are needed to harmoniously align the external video's content with the markings 2mrk1, 2mrk2, 2mrk3 on the main video 9im.

For instance, when the rendering process employs a perspective that is head-on or nearly head-on to the designated video-projection-area 2vpr, linear distortion adjustments may be needed. These adjustments involve resizing and reshaping the external video's images to accommodate the perspective of the rendering. Alternatively, in cases where the viewing angle is at an angle to the flat side of the three-dimensional object 2model9, rotation adjustments become essential. Such scenarios require rotating the external video's images to align with the orientation of the designated video-projection-area within the main video.

Moreover, perspectives that are off-center or slanted may necessitate a combination of adjustments, including both linear distortion and rotation. This could involve warping the external video's images to account for the specific perspective and creating the illusion of natural projection onto the flat side of the three-dimensional object. These fitting adjustments can vary widely, addressing the diverse range of potential viewing angles during the rendering process. The adaptive nature of these fittings ensures that the illusion of projection remains consistent across various perspectives, enhancing the visual cohesion of the overall scene and viewer experience.

FIG. 8E illustrates one embodiment of embedding adjusted images within the main video, extending the illusion of projection. In this embodiment, the process of embedding takes the meticulously fitted and adjusted images, referred to as 11im1, 11im2, 11im3, from the external video and seamlessly integrates them into the main video 9im. This integration occurs in conjunction with the respective markings 2mrk1, 2mrk2, 2mrk3 within the main video, aligning precisely with the designated video-projection-area 2vpr. As a result, the external video's content is convincingly projected onto the flat side of the three-dimensional object 2model9 within the main video 9im. Once embedded, the illusion of projection is sustained, creating a compelling visual effect that enhances the viewer's engagement. The culmination of this process leads to the creation of an extended main video denoted as 9im′, now enriched with the embedded external video 10im. This combined video is ready to be streamed out to external devices, allowing audiences to experience the captivating visual interplay of the integrated content. In a scenario where the main video 9im is a computer-generated imagery (CGI) rendered motion picture depicting a bustling cityscape, the three-dimensional object 2model9 represents a prominent advertising outdoor board located along a busy street. The designated video-projection-area 2vpr on the flat side of the advertising board provides an ideal canvas for projecting the external video 10im, which is an advertisement for a specific brand. As the CGI motion picture unfolds, the carefully adjusted images from the external video seamlessly integrate with the scene. The projected advertisement becomes an integral part of the urban landscape, conveying the message of the brand with a striking illusion of being projected onto the advertising board. Viewers are immersed in a dynamic visual experience where the virtual and real elements coalesce to create a memorable and impactful advertising presence within the CGI-rendered world.

In one embodiment, a scenario is considered where the main video 9im is a captivating motion picture streamed to a specific viewer's device. Within this motion picture, the three-dimensional object 2model9 takes the form of an interactive display in a futuristic setting. The designated video-projection-area 2vpr on the interactive display offers an opportunity for tailored content integration. The external video 10im is an engaging promotional video for a technology product, and it is strategically embedded within the interactive display. As the viewer watches the motion picture, the external video seamlessly integrates into the interactive display, enhancing the viewer's experience. This integration takes into account the viewer's preferences, demographic information, and past interactions to select the most relevant content for the external video. The illusion of projection onto the interactive display creates a personalized and immersive experience for the viewer, demonstrating how seamlessly integrated content can be tailored to individual preferences and context.

In one embodiment, another scenario is considered where the main video 9im portrays an immersive exploration of an art gallery showcasing diverse artworks. Within this context, the three-dimensional object 2model9 embodies a prominent canvas hanging on one of the gallery walls. This canvas serves as the designated video-projection-area 2vpr, inviting the integration of external visual elements. The external video 10im takes the form of a carefully chosen still image, seamlessly embedded into the canvas within the art gallery scene. This integration creates a seamless blend between the external image and the gallery's ambiance. As viewers engage with the main video, the embedded image becomes an integral part of the virtual art gallery, exemplifying the potential of merging static visual content with dynamic environments to enhance storytelling and viewer experience.

Moreover, within this artistic narrative, a dynamic dimension emerges where the actual image 10im can be tailored to match the viewer's preferences and characteristics. As viewers interact with the art gallery video, the external image seamlessly adapts based on factors such as the viewer's profile, interests, and past interactions. This personalized selection process ensures that the embedded image resonates with each viewer, creating a unique and engaging experience. The fusion of artistic representation and personalized adaptation underscores the versatility of integrated content, showcasing how technology can transform traditional art forms into interactive and personalized visual narratives.

In one embodiment, a different scenario is considered where the main video 9im is a documentary-style film exploring the rich history of a city. In this context, the three-dimensional object 2model9 represents an iconic historical monument featured in the documentary. While the main video is not necessarily rendered from a 3D scene, the designated video-projection-area 2vpr on the monument's surface presents an opportunity for content integration. The external video 10im is a series of archival images showcasing the monument's evolution over time. These images are thoughtfully adjusted and seamlessly embedded onto the monument's surface within the documentary footage. This integration enhances the storytelling by visually connecting the historical images with the real-world monument, creating an engaging narrative that brings the past and present together. This example showcases how integrated content can enrich non-3D scenes, adding layers of depth and context to the viewer's experience.

In one embodiment, and in scenarios where the main video 9im is not rendered from a 3D scene, an alternative approach can be employed to generate the markings. In this context, a sophisticated AI model specialized in identifying objects with flat surfaces in videos comes into play. This AI model is trained to analyze the main video and accurately locate suitable areas for embedding external content. The identified regions serve as the basis for generating the sequence of markings 2mrk1, 2mrk2, 2mrk3. Each marking corresponds to a designated area on a flat surface, aligning with the object of interest within the main video. By utilizing AI technology, the integration process adapts to different video sources, demonstrating the versatility of the system in accommodating various scenarios and enriching content integration with minimal user intervention.

In one embodiment, yet another scenario is considered where the main video 9im is streamed to a specific user in real time, tailored to their preferences and viewing history. As the user engages with the video, the embedding process takes place seamlessly. In this instance, the external video 10im is chosen from a curated set of possibilities, each catering to the user's interests. The integration process occurs on-the-fly as the user watches the main video, with the selected external video being adjusted and embedded into the scenes in real time. This live integration creates a personalized viewing experience, where the external content becomes an integral part of the narrative, aligning with the user's preferences and enhancing their engagement. This example showcases the power of real-time adjustments and personalized content integration, offering a dynamic and immersive viewing experience tailored to the individual viewer.

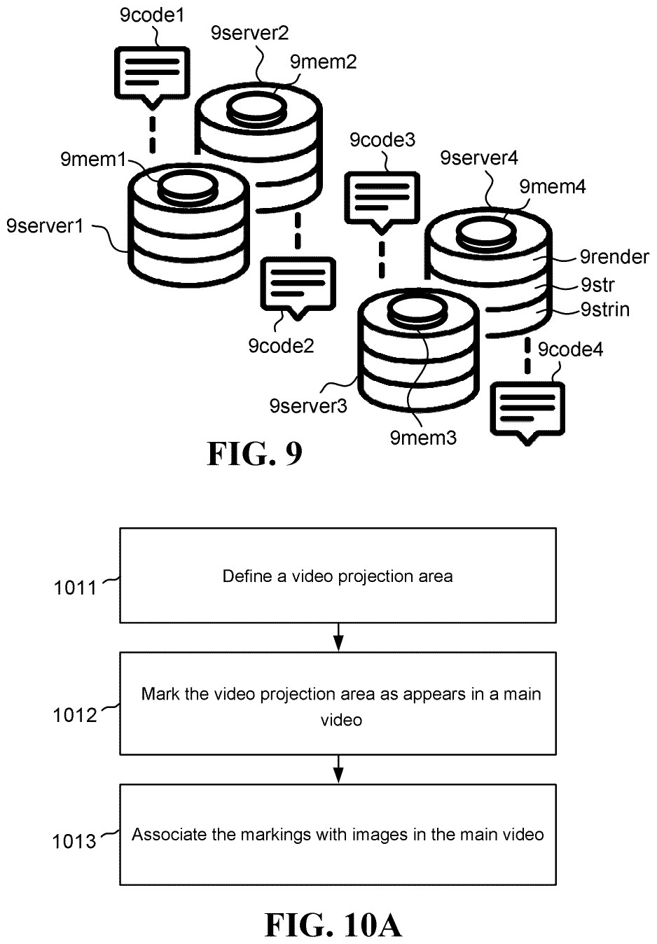

FIG. 9 illustrates one embodiment a system operative to define a video-projection-area 2vpr on a flat side of a three-dimensional object 2model9 within a 3D scene, enabling seamless integration of external video content into the main video 9im. The system comprises a video-projection-area defining sub-system 9server1 responsible for establishing the designated region on the 3D object, which serves as the canvas for embedding the external video. The marking generation and association sub-system 9server2 generates a sequence of markings 2mrk1, 2mrk2, 2mrk3 corresponding to instances of the video-projection-area within the main video. These markings are associated with the sequence of images 9im1, 9im2, 9im3 in the main video, enabling future embedding of the external video within the main video and in conjunction with the sequence of markings. The system also features an image fitting and embedding sub-system 9server3 responsible for adjusting each image in the external video stream to fit within the boundaries of the respective markings and embedding them in the main video, creating the illusion of projection on the flat side of the 3D object. Additionally, the system includes a streaming sub-system 9server4 configured to receive and process the main video and external video stream. The rendering module 9render within the streaming sub-system renders the finished main video with the embedded external video, while the streaming output module 9str delivers the finished video for streaming purposes. The streaming input module 9strin receives and processes the external video stream in real-time, the transcoding module (not depicted) converts the external video stream into a compatible format for integration, and the buffering module (not depicted) stores and manages streamed external video segments to ensure smooth playback and synchronization with the main video. This system configuration provides a comprehensive solution for integrating dynamic content seamlessly into pre-existing scenes.

One embodiment is a system operative to facilitate embedding of an external video stream within a main video of a certain scene, comprising: a video-projection-area defining sub-system 9server1 (FIG. 9A) configured to define a video-projection-area 2vpr associated with a flat side of a three-dimensional (3D) object 2model9 appearing in the main video 9im of the certain scene, wherein the main video comprises a sequence of images 9im1, 9im2, 9im3 of the certain scene; a marking generation and association sub-system 9server2 configured to generate a sequence of markings 2mrk1, 2mrk2, 2mrk3 in conjunction with the main video 9im, wherein each marking in the sequence represents a respective instance of the video-projection-area 2vpr as it appears in the respective image 9im1, 9im2, 9im3 of the main video and associate the sequence of markings with the sequence of images in the main video, thereby enabling future embedding of the external video 10im within the main video and in conjunction with the sequence of markings; an image fitting and embedding sub-system 9server3 configured to adjust each image in a sequence of images 10im1, 10im2, 10im3 in the external video stream to fit within the boundaries of the respective marking in the sequence of markings 2mrk1, 2mrk2, 2mrk3, in conjunction with the main video, and embed each of the adjusted images 11im1, 11im2, 11im3 within the main video, in conjunction with the respective marking in the sequence of markings, thereby creating an illusion that the external video 10im is being projected on the flat side of the 3D object 2model9 as it appears in the main video 9im.

In one embodiment, the system further comprising a streaming sub-system 9server4 configured to receive the main video 9im and the external video 10im, and generate a finished main video 9im′ with the external video 10im embedded therein, wherein the streaming sub-system comprises: a rendering module 9render configured to render the finished main video 9im′ with the embedded external video 10im; and a streaming output module 9str configured to deliver the finished main video 9im′ with the embedded external video 10im for streaming purposes.

In one embodiment, both the main video 9im and the external video 10im are pre-stored 9mem in the system.

In one embodiment, the main 9im video is pre-stored 9mem in the system and the external video 10im is streamed into the system in conjunction with said delivering of the finished video 9im′.

In one embodiment, both the main video 9im and the external video 10im are streamed into the system in conjunction with said delivering of the finished video 9im′.

In one embodiment, the streaming sub-system 9server4 further comprises: a streaming input module 9strin configured to receive and process the external video stream 10im for real-time streaming into the system; a transcoding module configured to convert the external video 10im stream into a compatible format for seamless integration with the main video 9im; a buffering module configured to store 9mem and manage the streamed external video segments to ensure smooth playback and synchronization with the main video.

In one embodiment, the system further comprising a main video downloading module configured to download the main video 9im in its entirety for local storage 9mem, enabling subsequent processing and embedding of the external video stream 10im in conjunction with the downloaded main video.

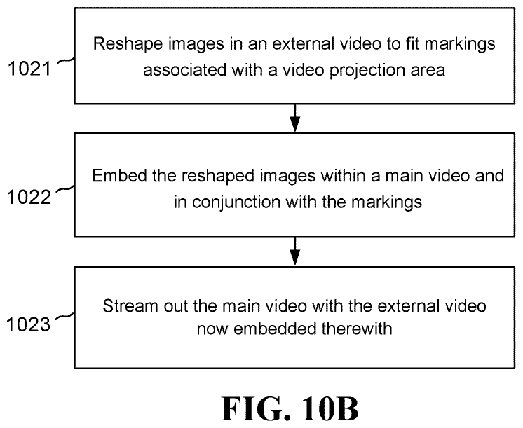

FIG. 10A illustrates one embodiment of a method (FIG. 10A) for facilitating embedding of an external video stream within a main video of a certain scene. The method includes: In step 1011, defining a video-projection-area 2vpr (FIG. 8A) associated with a flat side of a three-dimensional (3D) object, e.g., 2model9 (FIG. 8A), appearing in the main video 9im (FIG. 8B) of the certain scene, in which the main video 9im comprises a sequence of images 9im1, 9im2, 9im3 of the certain scene. In step 1012, generating a sequence of markings 2mrk1, 2mrk2, 2mrk3 (FIG. 8B) in conjunction with the main video 9im, in which each of the markings in the sequence is a marking of a respective one instance of the video-projection-area 2vpr as appears in the respective image in the main video. In step 1013, associating the sequence of markings 2mrk1, 2mrk2, 2mrk3 with the sequence of images 9im1, 9im2, 9im3 in the main video, thereby allowing future embedding 2emb (FIG. 8E) of the external video 10im within the main video 9im and in conjunction with the sequence of markings, so as to create an illusion (FIG. 8E) that the external video stream 10im (FIG. 8C) is projected on the flat side of the 3D object 2model9.

In one embodiment, the method further comprises: fitting 2fit (FIG. 8D), by re-shaping, each of a sequence of images 10im1, 10im2, 10im3 (FIG. 8C) in the external video stream into boundaries of the respective marking in the sequence of markings 2mrk1, 2mrk2, 2mrk3 and in conjunction with the main video 9im, thereby generating a respective sequence of adjusted images 11im1, 11im2, 11im3 (FIG. 8E) associated with the external video 10im; and embedding 2emb (FIG. 8E) each of the adjusted images 11im1, 11im2, 11im3 within the main video 9im and in conjunction with the respective marking in the sequence of markings 2mrk1, 2mrk2, 2mrk3, thereby creating an illusion that the external video 10im is being projected on the flat side of the 3D object 2model9 as appears in the main video 9im.

In one embodiment, the method further comprises: receiving information regarding a current viewer of the main video 9im; and selecting, based on said information and prior to said fitting 2fit and embedding 2emb, the external video 10im from a set of possible external videos.

In one embodiment, said information is received only after: (i) the entire associated sequence of images 9im1, 9im2, 9im3 of the certain scene already exists and (ii) said association of the sequence of markings 2mrk1, 2mrk2, 2mrk3 with the sequence of images in the main video 9im is already done.

In one embodiment, said information is received at least one minute after the sequence of markings 2mrk1, 2mrk2, 2mrk3 is already done.

In one embodiment, said information is received at least ten minutes after the sequence of markings 2mrk1, 2mrk2, 2mrk3 is already done.

In one embodiment, said fitting 2fit and embedding 2emb, of the sequence of images 10im1, 10im2, 10im3 of the external video 10im, is done only after the entire main video 9im is all set and already includes: (i) all of the associated sequence of images 9im1, 9im2, 9im3 of the certain scene and (ii) said association the sequence of markings 2mrk1, 2mrk2, 2mrk3 with the sequence of images 9im1, 9im2, 9im3 in the main video.

In one embodiment, said main video 9im is 3D-rendered from a 3D computer-generate scene 2model′ (FIG. 8A); said 3D object 2model9 is a synthetic 3D object appearing in the 3D computer-generate scene 2model; and said definition of the video-projection-area 2vpr is done in conjunction with the 3D computer-generate scene 2model′ and 3D object 2model9, prior to the main video 9im being 3D-rendered from the 3D computer-generate scene 2model9.

In one embodiment, said flat side of the 3D object 2model9 is defined in 3D space, in which the method further comprises: generating a sequence of pre-markings 2pre (FIG. 8A), in which the pre-markings are generated in conjunction with the flat side of the 3D object 2model9 and in 3D space.

In one embodiment, said pre-marking 2pre is done by 3D marking the flat side of the 3D object 2model9; and said generating of the sequence of markings 2mrk1, 2mrk2, 2mrk3 is done by two-dimensionally locating the 3D markings in the main video 9im.

In one embodiment, said definition of the video-projection-area 2vpr is done in conjunction with a machine-learning model trained to identify flat surfaces of objects in videos.

In one embodiment, the external video 10im is associated with at least one of: (i) an advertisement video, (ii) a music video, (iii) a news clip, and (iv) an tutorial video.

In one embodiment, said markings 2mrk are done by assigning a pre-determined specific color to the pixels associated with the flat side of the 3D object 2model9.

In one embodiment, said markings 2mrk are done by assigning a specific meta-data to the pixels associated with the flat side of the 3D object 2model9.

In one embodiment, said markings 2mrk are done by assigning a specific meta-data that defines the two-dimensional location of the markings in the sequence of images 9im1, 9im2, 9im3 in the main video 9im.

In one embodiment, said defining and generating of the sequence of markings 2mrk1, 2mrk2, 2mrk3 is done once; and said fitting 2fit and embedding 2emb is done multiple times respectively in conjunction with multiple external videos 10im.

In one embodiment, each of the fitting 2fit and embedding 2emb, of the respective one of the multiple external videos 10im, is done based on who is watching the main video 9im.

In one embodiment, each of the fitting 2fit and embedding 2emb, of the respective one of the multiple external videos 10im, is done based on additional information associated with who is watching the main video, in which said additional information comprises at least one of: (i) age, (ii) gender, and (iii) past preferences.

In one embodiment, said defining and generating of the sequence of markings 2mrk1, 2mrk2, 2mrk3 is done by post-processing the main video 9im; and said fitting 2fit and embedding 2emb is done is real time while a person is watching the main video 9im.

FIG. 10B illustrates one embodiment of a method for embedding an external video stream within a main video of a certain scene so as to create an illusion of the external video being projected on a flat side of a three-dimensional (3D) object appearing in the main video. The method includes: In step 1021, reshaping a sequence of images 10im1, 10im2, 10im3 in the external video stream 10im to fit within boundaries of respective markings 2mrk1, 2mrk2, 2mrk3 associated with a video-projection-area 2vpr on the flat side of the 3D object 2model9. In step 1022, embedding 2emb each reshaped image 11im1, 11im2, 11im3 within the main video 9im, in conjunction with the respective marking 2mrk1, 2mrk2, 2mrk3 associated with the video-projection-area, thereby creating the illusion of the external video 10im being projected on the flat side of the 3D object 2model9 in the main video 9im. In step 1023, streaming out the main video 9im′, with the external video 10im now embedded therewith, to an external device.

In one embodiment, the method further comprises: receiving the external video 10im, including the markings 2mrk1, 2mrk2, 2mrk3, as an input stream comprising the sequence of images.

In one embodiment, said receiving of the external video 10im as an input stream and consequently streaming out of the main video 9im′, with the external video now embedded therewith, are done concurrently.

In one embodiment, said reshaping and embedding of the sequence of images 10im1, 10im2, 10im3 into the main video 9im is done in real-time and concurrently to said streaming out of the main video 9im′.

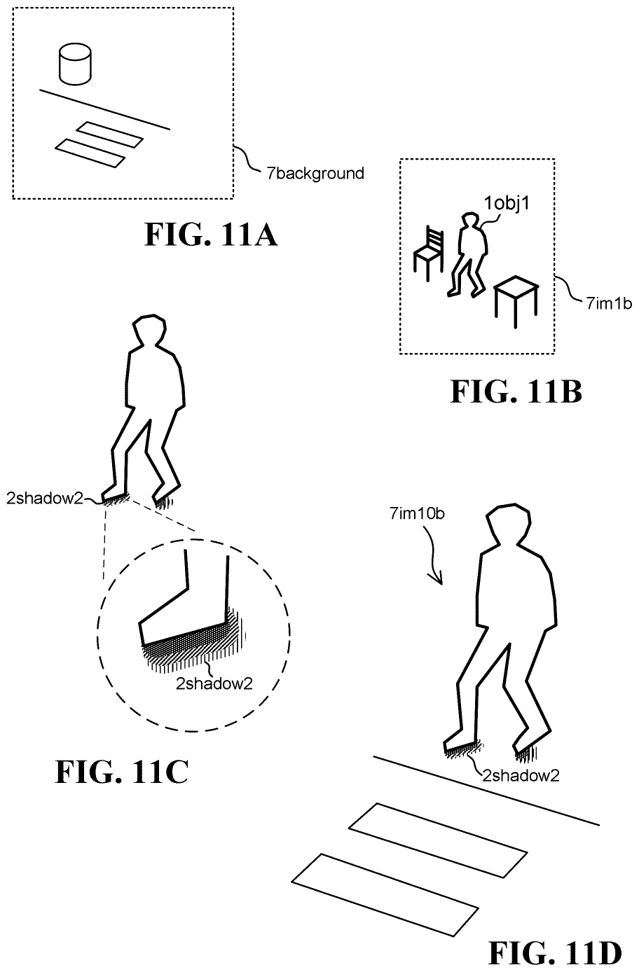

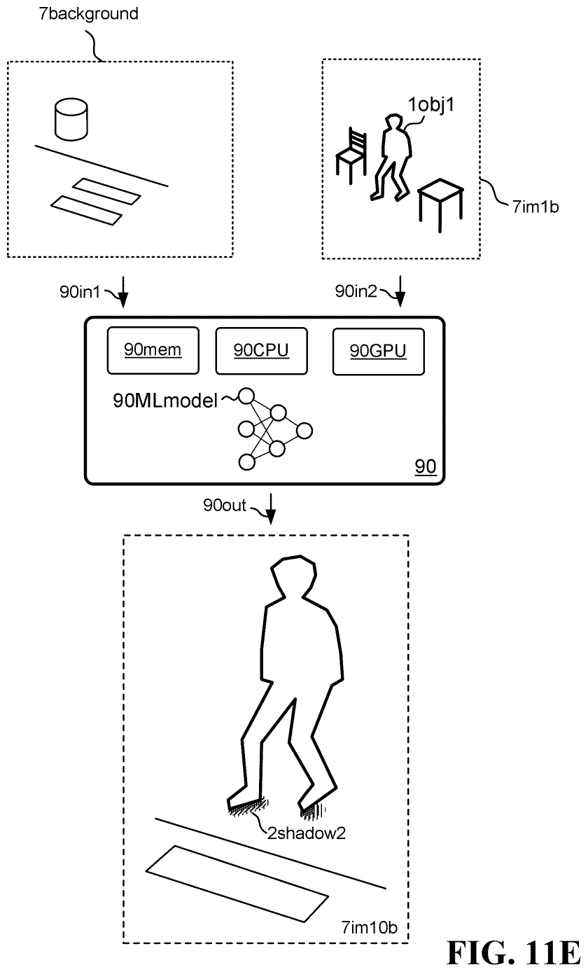

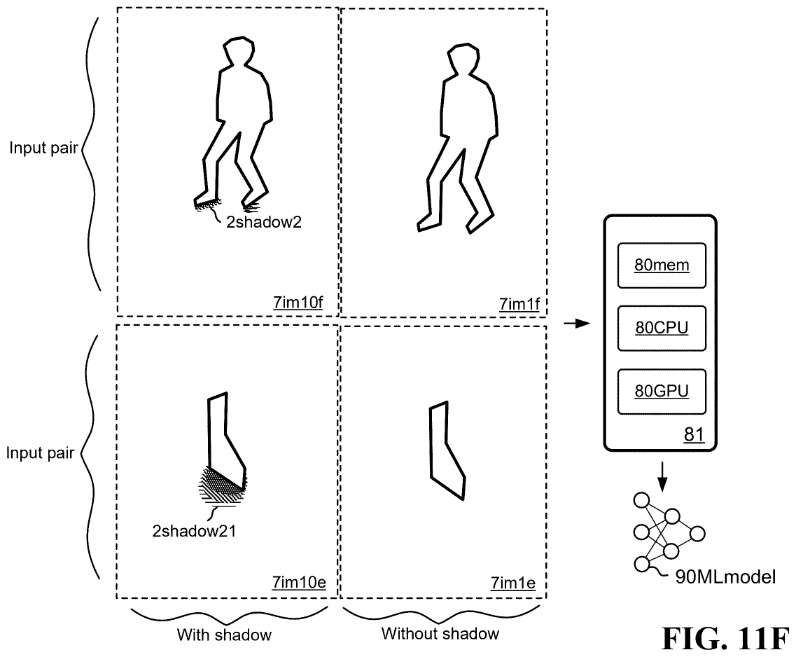

FIG. 11A illustrates one embodiment of a background image 7background featuring a simple scene. The scene includes a sidewalk, indicated by a horizontal line, and a zebra crossing. The background is intended to be used as a canvas where an object will be integrated.

FIG. 11B illustrates one embodiment of an object 1obj1 to be integrated into a background image, specifically a person. The object appears in a corresponding image 7im1b that may include other items that are to be ignored.

FIG. 11C illustrates one embodiment of a contact shadow generated for the object. The detailed view shows the contact shadow 2shadow2 extending from the person's feet, indicating the points of contact with the ground. The hatching suggests the shadow's semi-transparent or diffuse nature.

FIG. 11D illustrates one embodiment of the object integrated into the background image, including the contact shadow. A final rendered image 7im10b is shown, where the person is integrated into the background. The person now casts a contact shadow 2shadow2 on the ground, creating the illusion of the person standing within the scene. The shadow's shape and position are consistent with the person's pose.

FIG. 11E illustrates one embodiment of an inference system 90 configured to generate a realistic composite image including contact shadows. The system 90 comprises hardware components including a memory 90mem, a central processing unit 90CPU, and a graphics processing unit 90GPU, which are collectively operative to execute a machine learning model 90MLmodel. The system 90 is configured to receive multiple inputs required for the shadow generation process. As illustrated, a first input 90in1 is provided corresponding to the background image 7background (as previously described in FIG. 11A). A second input 90in2 is provided corresponding to the image 7im1b containing the object 1obj1 (as previously described in FIG. 11B).

In one embodiment, the machine learning model 90MLmodel performs an inference process on the received inputs 90in1 and 90in2. The model is trained to analyze the spatial relationship between the object 1obj1 and the background 7background to synthesize a contact shadow that facilitates the visual grounding of the object. The system 90 generates an output 90out, which corresponds to the final integrated image 7im10b. As shown in the output 90out, the integrated image 7im10b depicts the object from the input image 7im1b composited onto the background 7background, now featuring a generated contact shadow 2shadow2 that was synthesized by the machine learning model 90MLmodel during the inference process.

FIG. 11F illustrates one embodiment of a training system 81 operative to train the machine learning model 90MLmodel (previously described in FIG. 11E) to generate realistic contact shadows. The training system 81 comprises computational hardware including a memory 80mem, a central processing unit 80CPU, and a graphics processing unit 80GPU, which work in conjunction to execute a training algorithm (such as backpropagation).

In one embodiment, the training process utilizes a dataset comprising paired examples. As illustrated, the training data is organized into “Input pairs.” A first component of the pair represents the “ground truth” or target state, designated as “With shadow” 7im10e, 7im10f. This includes images such as 7im10f, which depicts an object (e.g., a person) casting a realistic contact shadow 2shadow2, and detailed views showing specific shadow characteristics like the contact point shadow 2shadow21 in 7im10e. A second component of the pair represents the input state, designated as “Without shadow” 7im1e, 7im1f. This includes images such as 7im1f, which depicts the same object and pose but lacks the contact shadow.

During the Training process, the system 81 provides the “Without shadow” representations (e.g., 7im1f, 7im1e) to the machine learning model 90MLmodel. The model attempts to predict or generate the corresponding shadow. The system 81 then compares the model's output against the “With shadow” representations (e.g., 7im10f, 7im10e) containing the actual shadows 2shadow2 and 2shadow21. Based on the difference between the generated output and the target images, the system 81 updates the parameters of the 90MLmodel to minimize the error, thereby teaching the model to synthesize realistic contact shadows from shadow-less inputs.

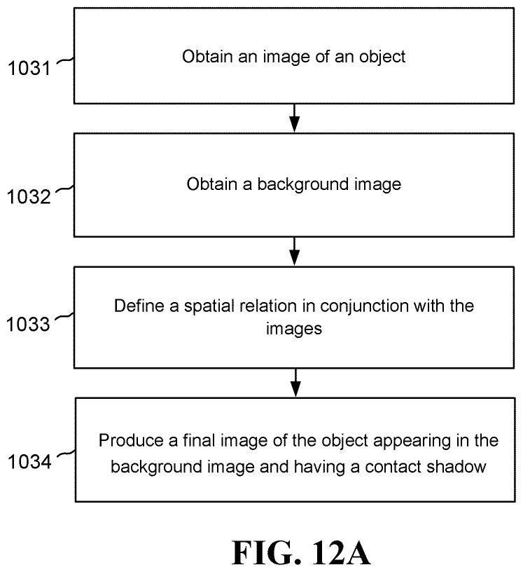

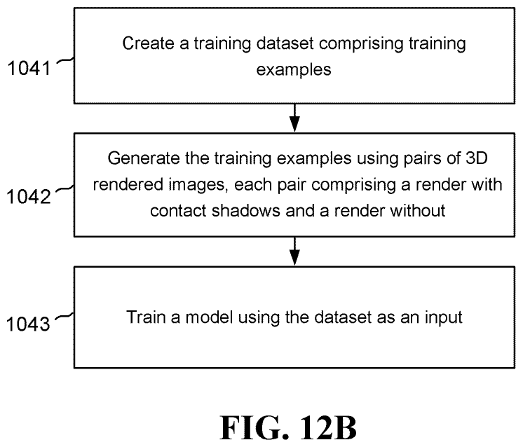

FIG. 12A illustrates one embodiment of a method for generating contact shadows 2shadow2 (FIG. 11C), comprising: In step 1031, obtaining at least one image 7im1b (FIG. 11B) of at least one object 1obj1 (FIG. 11B); In step 1032, obtaining at least one background image 7background (FIG. 11A) constituting a background for said at least one image respectively; In step 1033, defining a respective location in the respective background image 7background at which the respective image 7im1b of the at least one object 1obj1 is to appear as if integrated into the background; and In step 1034, providing the at least one image 7im1b (via input 90in2, FIG. 11E) and the respective background 7background (via input 90in1, FIG. 11E) to a machine learning model 90MLmodel (FIG. 11E) trained to generate contact shadows 2shadow2, thereby producing at least one respective final image 7im10b (FIG. 11D, output 90out in FIG. 11E) showing the respective at least one object 1obj1 casting a contact shadow 2shadow2 in conjunction with the respective location, consequently producing a realistic illusion that the at least one object 1obj1 is in physical contact with at least one element appearing in the respective background image 7background.

In one embodiment, the at least one image 7im1b of the at least one object 1obj1 and the at least one background image 7background are provided to the machine learning model 90MLmodel as a single composite image.

In one embodiment, the method further comprises providing to the machine learning model 90MLmodel at least one mask associated with the single composite image, the at least one mask identifying, for each pixel in the composite image, whether the pixel corresponds to the at least one object 1obj1 or to the background image 7background, in which said mask constitutes said defining of the respective location in the respective background image at which the respective image of the at least one object is to appear.

In one embodiment, the single composite image is one composite image of a sequence of composite images generated by: capturing a video sequence of the at least one object 1obj1 over a period of time; obtaining tracking information representing movement and orientation 9mvnt (FIG. 1A) of a camera 8cam (FIG. 1B) that captured the video sequence over the period of time; generating at least one 3D-renderable representation 2model10 (FIG. 2) of the at least one object 1obj1 based on the video sequence, each 3D-renderable representation corresponding to a respective viewpoint of the camera; positioning the at least one 3D-renderable representation 2model10 within a synthetic 3D scene 2model (FIG. 3), in which said positioning facilitates said defining of the respective location; and rendering the synthetic 3D scene 2model with the at least one 3D-renderable representation 2model10 positioned therein from a sequence of rendering viewpoints 9view10 (FIG. 4A) derived from the tracking information, thereby producing the sequence of composite images, each composite image depicting the synthetic 3D scene with the at least one 3D-renderable representation integrated therein.

In one embodiment, said positioning the at least one 3D-renderable representation 2model10 within the synthetic 3D scene 2model, in conjunction with rendering the synthetic 3D scene from the sequence of rendering viewpoints 9view10, fully defines the respective location of the at least one object 1obj1 within each composite image of the sequence of composite images.

In one embodiment, the machine learning model 90MLmodel is further trained to maintain shadow consistency across the sequence of composite images, such that the contact shadow 2shadow2 generated for the at least one 3D-renderable representation 2model10 of the at least one object 1obj1 in each composite image is consistent with the contact shadows generated in other composite images of the sequence, thereby producing a realistic illusion of a consistently changing shadow that corresponds to the movement and orientation 9mvnt of the camera 8cam and the positioning of the at least one 3D-renderable representation 2model10 within the synthetic 3D scene 2model over the period of time.

In one embodiment, the at least one image 7im1b of the at least one object 1obj1 and the at least one background image 7background are provided to the machine learning model 90MLmodel as separate images (e.g., via inputs 90in2 and 90in1 respectively, FIG. 11E), and wherein defining the respective location in the respective background image at which the respective image of the at least one object is to appear comprises receiving input data that specifies at least the respective location.

In one embodiment, the input data that specifies at least the respective location is determined by identifying a boundary of the at least one object 1obj1 in the at least one image 7im1b of the at least one object, and associating the identified boundary with a corresponding location in the at least one background image 7background to define the respective location.

In one embodiment, the at least one object 1obj1 is a person (FIG. 11B), wherein the at least one background image 7background depicts a ground surface on which the person is to appear to be standing, and wherein the machine learning model 90MLmodel is further trained to modify the at least one characteristic of the shadow 2shadow2 to extend the contact shadow to cover an expected contact area between the person and the ground surface.

In one embodiment, the at least one background image 7background depicts at least one additional surface besides the ground surface, and wherein the machine learning model 90MLmodel is further trained to generate contact shadows 2shadow2 that extend to and realistically interact with said at least one additional surface, such that the contact shadow appears to be cast upon multiple surfaces in a manner consistent with the geometry and orientation of the surfaces depicted in the at least one background image and the defined location of the at least one object 1obj1.

In one embodiment, the machine learning model 90MLmodel is further trained to generate an ambient occlusion effect in proximity to an area where the at least one object 1obj1 appears to make contact with at least one element in the at least one background image 7background, the ambient occlusion effect simulating the subtle darkening that occurs in areas with limited ambient light.

In one embodiment, the at least one object 1obj1 is a person, and wherein the machine learning model 90MLmodel is further trained to incorporate physics-based principles of motion, such as walking, into the generation of the contact shadow 2shadow2, such that the generated contact shadow changes in a manner consistent with the expected physical movement of the person and the contact points between the person and the at least one element in the at least one background image 7background, thereby enhancing the realistic illusion of the person interacting with the background.

In one embodiment, the contact shadow 2shadow2 generated by the machine learning model 90MLmodel is a directional shadow that is defined at least in part by a specified or inferred direction and intensity of a light source, such that the shape, size, and orientation of the contact shadow are consistent with the direction and intensity of the light source relative to the at least one object 1obj1 and the at least one element in the at least one background image 7background with which the at least one object appears to make contact.

FIG. 12B illustrates one embodiment of a method for training a machine learning model 90MLmodel (FIG. 11F) to generate contact shadows 2shadow2 (FIG. 11C), comprising: In step 1041, creating a training dataset (FIG. 11F) comprising a plurality of training examples, each training example comprising: an input image depicting at least one object (e.g., 7im1f or 7im1e, FIG. 11F); and a corresponding target image (e.g., 7im10f or 7im10e, FIG. 11F), wherein the target image depicts the at least one object integrated into a background image, and wherein the target image includes a contact shadow (e.g., 2shadow2 or 2shadow21, FIG. 11F) corresponding to the at least one object; In step 1042, generating the training examples by: providing a synthetic 3D scene 2model corresponding to the background image; positioning at least one 3D object within the synthetic 3D scene; rendering a first image of the synthetic 3D scene with the at least one 3D object positioned therein and without simulating a shadow cast by the at least one 3D object; rendering a second image of the synthetic 3D scene with the at least one 3D object positioned therein and with a simulated shadow cast by the at least one 3D object, the simulated shadow including the contact shadow; and in step 1043, using the second image as the target image, wherein the first image is used in training the machine learning model 90MLmodel to learn to generate contact shadows that are present in the target image; and training the machine learning model using the training dataset, wherein the machine learning model learns to generate contact shadows for the at least one object in the input image based on the target image.

FIG. 12B also illustrates another embodiment of a method for training a machine learning model 90MLmodel to generate ambient occlusion effects for an object, comprising: In step 1041, creating a training dataset comprising a plurality of training examples, each training example comprising: an input image (e.g., 7im1f, FIG. 11F) depicting at least one object, wherein the input image does not include a background and/or includes a background that is not used in training the model to generate ambient occlusion effects; and a corresponding target image (e.g., 7im10f, FIG. 11F) depicting the at least one object with an ambient occlusion effect (e.g., 2shadow2) that simulates the darkening that occurs in areas with limited ambient light, particularly in proximity to areas where the at least one object would appear to make contact with other surfaces if such surfaces were present; In step 1042, generating the training examples by: providing a 3D representation of the at least one object; rendering a first image of the 3D representation without simulating ambient occlusion, to be used as the input image; rendering a second image of the 3D representation with a simulated ambient occlusion effect, to be used as the target image; and in step 1043, training the machine learning model 90MLmodel using the training dataset, wherein the machine learning model learns to generate the ambient occlusion effect for the at least one object in the input image based on the target image, and wherein the model learns to generate said ambient occlusion effect based on the at least one object, even when a background is not present in the input image and/or when a full contact shadow is not present or readily determinable.

In one embodiment, the machine learning model 90MLmodel (FIGS. 11E, 11F) comprises at least one of: a diffusion model, a generative adversarial network (GAN), a variational autoencoder (VAE), and a neural network trained to generate images.

It is noted that the machine learning model's 90MLmodel ability to generate realistic contact shadows 2shadow2 and ambient occlusion is not restricted by the specific method used to represent the object being integrated into the scene. The object can be represented in various ways, including, but not limited to: a simple 2D image 7im1b composited onto a background; a “3D-renderable representation” 2model10 (which, as used herein, encompasses a spectrum of geometries, from truly flat 2D sprites to “flat-like” representations with slight curvature, to complete 3D models); or a fully detailed 3D object rendered within a 3D scene. Regardless of the chosen representation, the model's 90MLmodel performance relies on its generalization capabilities, derived from training on diverse data encompassing various object geometries, surface orientations, and optionally lighting conditions. The model 90MLmodel learns the underlying physical principles of light and shadow interaction, and its ability to apply these principles is a function of its training (via training system 81, FIG. 11F), its learned understanding of these principles, and potentially, any inherent physical modeling incorporated into its architectural design. Therefore, the input to the shadow generation model 90MLmodel can be any representation that allows the model to perceive the object's shape, position, and relationship to its surroundings, and the output will be a realistic shadow 2shadow2 and/or ambient occlusion effect consistent with that perceived information.

Furthermore, it is important to distinguish the aforementioned model-based approach to generating ambient occlusion from traditional methods used in 3D rendering engines. Conventional 3D graphics engines typically calculate ambient occlusion based on explicit 3D models of the scene and objects, using techniques like ray tracing or screen-space ambient occlusion (SSAO). These techniques rely on having complete 3D geometric information available. In contrast, the present invention utilizes a machine learning model 90MLmodel to generate ambient occlusion effects without requiring explicit, complete 3D models of the scene or the objects. The input to the model can be a 2D image 7im1b (or a sequence of 2D images), a “3D-renderable representation” 2model10 (which, as previously defined, may have varying degrees of 3D detail), or any other representation from which the model can infer the spatial relationships between the object and its surroundings. The model 90MLmodel learns to infer the 3D spatial relationships necessary for ambient occlusion generation from this, potentially limited, input data, based on its training. This approach allows for the generation of ambient occlusion in scenarios where full 3D scene information is unavailable, impractical to obtain, or computationally expensive to process. This represents a significant departure from, and improvement over, traditional 3D engine-based techniques. The model 90MLmodel achieves a projected 3D perception, allowing it to simulate the darkening effects of ambient occlusion even from 2D or incomplete 3D input.

In one embodiment, a critical aspect of shadow consistency, particularly when applied to video sequences, is the generation of temporally consistent contact shadows 2shadow2 and ambient occlusion effects. The machine learning model 90MLmodel is specifically trained to ensure that these effects do not flicker, jump, or otherwise behave unnaturally from frame to frame. This temporal consistency is achieved through both the design of the training data (e.g., sequences of images in FIG. 11F) and the architecture of the model itself. The training data includes video sequences where the shadows and ambient occlusion change realistically over time, reflecting the motion of the objects, camera, and light sources. The model architecture may incorporate elements specifically designed to process sequential data, such as recurrent neural networks (RNNs), transformers, or other temporal modeling techniques. This allows the model 90MLmodel to learn long-range temporal dependencies and maintain consistency even over extended video sequences. While model-based approach to generating ambient occlusion can be applied to single images (which can be considered a special case of a video with a single frame), an additional benefit of this approach lies in its ability to handle video sequences with realistic and temporally consistent shadow and ambient occlusion effects.

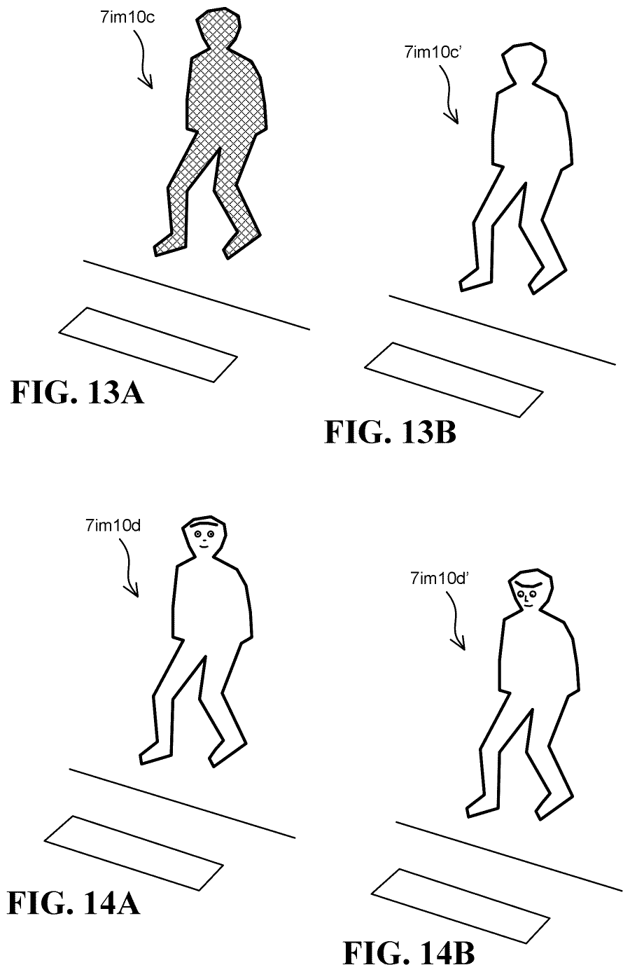

FIG. 13A illustrates one embodiment of an initial object representation 7im10c with a texture that is inconsistent with its environment. In this embodiment, the representation 7im10c depicts a human figure placed within a scene context suggested by a ground plane and markings. The texture applied to the human figure, indicated by a crosshatch pattern, may have originated directly from a source recording of a real-world object. However, due to differences in lighting conditions between the original capture environment and the synthetic environment into which the representation is placed, a visual inconsistency arises. Specifically, the contrast, brightness, or overall tonal values of the texture on 7im10c may not match the ambient lighting, light sources, or shadowing present in the surrounding scene, causing the representation to appear artificial or disconnected from its environment. This initial representation 7im10c serves as an input to an enhancement process.

FIG. 13B illustrates one embodiment of an enhanced object representation 7im10c′ with a corrected texture contrast and preserved identity. The representation 7im10c′ is the output of a diffusion-based generative model after processing the initial representation 7im10c shown in FIG. 13A. In this enhanced version, the texture of the human figure has been adaptively adjusted. The generative model has modified the contrast characteristics of the object's appearance to better match the lighting of the synthetic environment, resulting in a more cohesive and realistic visual integration. Notably, while correcting the contrast, the model has preserved the core identity and form of the object. The outline and recognizable features of the human figure remain consistent with the initial representation, demonstrating the model's ability to perform targeted visual enhancements while adhering to identity preservation constraints provided by object appearance information.

FIG. 14A illustrates one embodiment of an initial human representation 7im10d whose gaze direction is inconsistent with the synthetic environment. The representation 7im10d depicts a human figure positioned near a zebra crossing within a synthetic scene. In this initial state, the human's head orientation and gaze, indicated by the features on the face, are directed forward, potentially towards the viewpoint of an original camera or in a neutral pose. This gaze direction does not align with the immediate environmental context, which would naturally prompt a person to look at the crosswalk or check for traffic before crossing. This lack of contextual interaction makes the depiction seem less natural and reduces the believability of the human's presence within the scene. This initial representation 7im10d, with its contextually inconsistent gaze, serves as an input for a generative enhancement process.

FIG. 14B illustrates one embodiment of an enhanced human representation 7im10d′ with an adaptively corrected gaze direction. The representation 7im10d′ is the output generated by the diffusion-based generative model after processing the initial representation 7im10d from FIG. 14A. The model, guided by an understanding of human-environment interactivity, has adaptively modified the depiction of the human's head and facial features. The gaze of the human representation is now directed downwards towards the zebra crossing on the ground. This subtle but significant adjustment creates a narrative and enhances perceived realism, suggesting the human is aware of and about to interact with their environment. This demonstrates the model's capability to perform targeted, context-aware modifications to improve human-environment interactivity, all while preserving the core identity of the human figure.

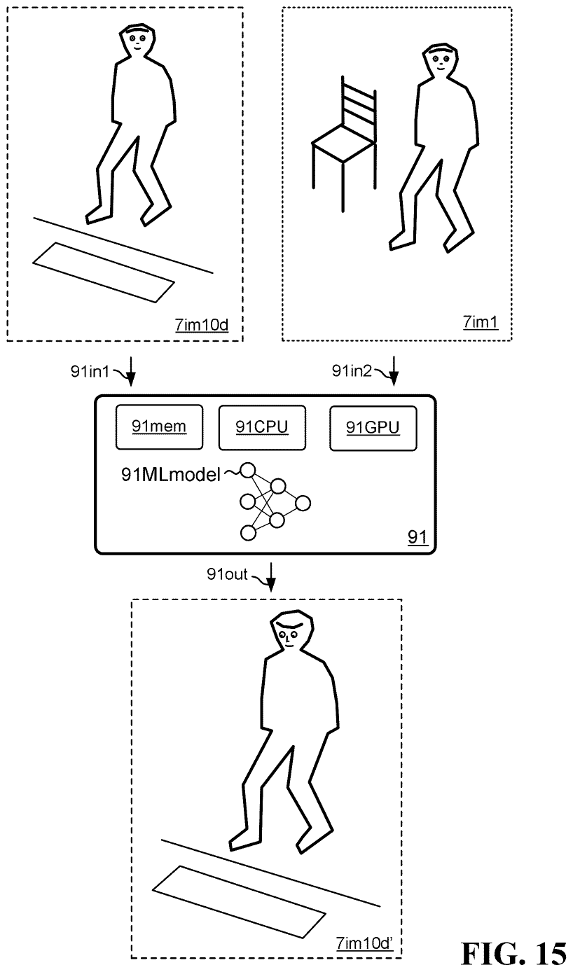

FIG. 15 illustrates one embodiment of a system 91 performing an inference process to generate an enhanced object representation 7im10d′ from an initial object representation 7im10d and an original source image 7im1. The system 91 represents an embodiment of a computer system configured to execute the enhancement method. The process begins with receiving multiple inputs. A first input 91in1 comprises the initial composite frame 7im10d, which depicts a human figure with a contextually inconsistent gaze, as previously described in FIG. 14A. A second input 91in2 comprises original source information, in this case represented by an image 7im1 that contains the appearance and identity information of the real-world object.

These inputs are processed by the system 91, which may comprise one or more processors 91CPU, graphics processing units 91GPU, and memory 91mem. Stored within the system's memory or accessed by it is a pre-trained diffusion-based generative model, depicted as 91MLmodel. During inference, the generative model 91MLmodel processes the initial composite frame 7im10d, guided and conditioned by the object appearance information derived from the original source image 7im1. The model synthesizes a new frame by iteratively applying its learned function, which is designed to improve visual integration while preserving identity. The final output of this inference process is an enhanced output 91out, which contains the enhanced object representation 7im10d′. As shown, the enhanced representation 7im10d′ now has a corrected gaze direction, demonstrating the successful application of the generative model to create a more realistic and contextually aware composite image.

One embodiment is a system for generating an enhanced video sequence depicting a real-world object integrated into a synthetic environment. In one embodiment, the system 91 comprises a first input interface configured to receive an initial composite video sequence, such as the input 91in1 containing frame 7im10d. Frames of said initial composite video sequence depict representations of the real-world object integrated within corresponding depictions of the synthetic environment, and said initial composite video sequence relates to an original source recording of the real-world object. The system 91 further comprises a second input interface configured to receive object appearance attributes characterizing the real-world object, such as the input 91in2 containing source image 7im1. Said object appearance attributes are derived from the original source recording. The system 91 further comprises a model storage, such as memory 91mem, configured to store a diffusion-based (or otherwise) generative model 91MLmodel. The system 91 also comprises at least one processor, such as 91CPU and/or 91GPU, communicatively coupled to the first input interface, the second input interface, and the model storage 91mem. The at least one processor is configured to: access the diffusion-based generative model 91MLmodel from the model storage 91mem; and process the initial composite video sequence using the accessed diffusion-based generative model 91MLmodel to generate an enhanced composite video sequence, such as the output 91out containing enhanced frame 7im10d′. In said processing, the diffusion-based generative model 91MLmodel is conditioned on both the content of the initial composite video sequence received via the first input interface and the object appearance attributes received via the second input interface to generate the enhanced composite video sequence. Furthermore, the generated enhanced composite video sequence, as a result of said conditioned processing, exhibits visual characteristics consistent with the received object appearance attributes, while demonstrating improved visual integration between the representations of the real-world object and the depictions of the synthetic environment compared to the initial composite video sequence. The system 91 further comprises an output interface configured to provide the generated enhanced composite video sequence via output 91out.

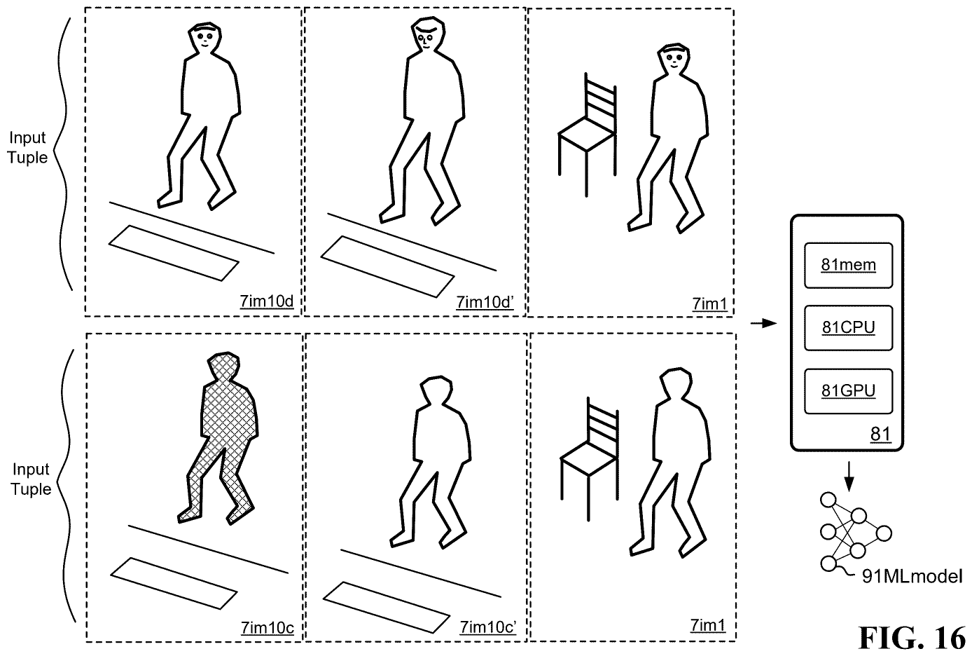

FIG. 16 illustrates one embodiment of a training process for the generative model 91MLmodel. The goal of the training process is to teach the model how to perform the enhancements described previously. The process relies on a dataset comprised of numerous training data tuples. Two examples of an Input Tuple are shown to represent the plurality of data samples used during training. Each Input Tuple provides the necessary information for one training iteration.

As shown in the top example Input Tuple, the training data comprises an initial composite frame 7im10d, an original source image 7im1 containing the object appearance information, and a corresponding target enhanced frame 7im10d′. The target frame 7im10d′ represents the “ground truth” or ideal output, where the object is perfectly integrated with the desired enhancement (in this case, corrected gaze). A second example Input Tuple is shown at the bottom, comprising an initial composite frame 7im10c (with inconsistent contrast), its corresponding original source information (again represented by 7im1), and its target enhanced frame 7im10c′ (with corrected contrast).

During a training step, an Input Tuple is fed into a training system 81, which comprises components such as memory 81mem, a CPU 81CPU, and a GPU 81GPU. The system 81 uses the tuple to calculate a loss value by comparing the output of the model 91MLmodel (when processing the initial frame and guided by the source information) with the target enhanced frame. This loss value, which may include both reconstruction and identity preservation components, is then used to update the internal weights of the model 91MLmodel via backpropagation. This iterative process, repeated over the entire dataset, enables the model 91MLmodel to learn the complex function required to transform various types of imperfect initial composites into high-quality, identity-preserved enhanced composites.

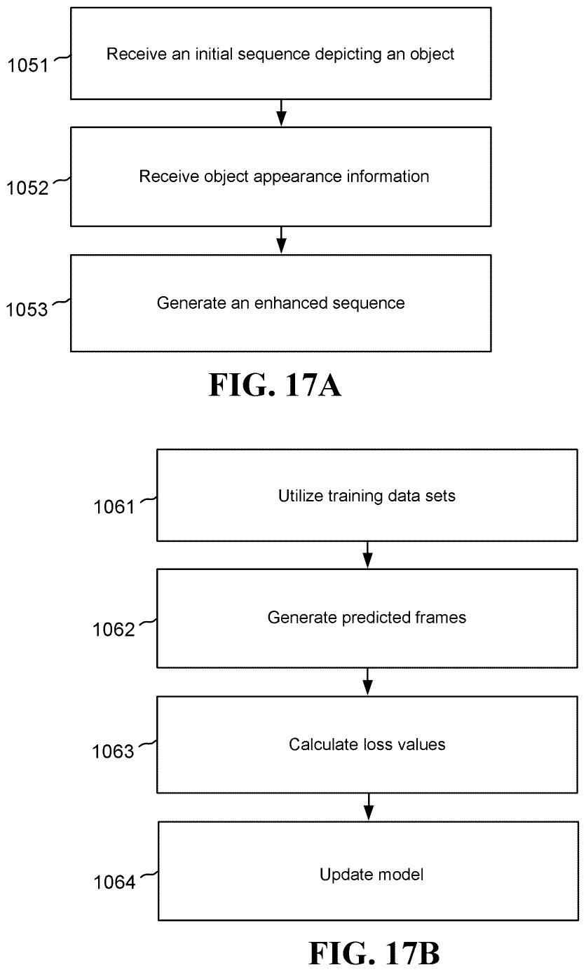

FIG. 17A illustrates one embodiment of a method for generating an enhanced video sequence depicting a real-world object 1obj1 integrated into a synthetic environment. In one embodiment, the method comprises a step 1051 of receiving an initial composite video sequence, for example a sequence containing frames such as 7im10c (FIG. 13A) or 7im10d (FIG. 14A). Frames of the initial composite video sequence depict representations of the real-world object 1obj1 integrated within corresponding depictions of the synthetic environment, and the initial composite video sequence relates to an original source recording of the real-world object 1obj1. The method further comprises a step 1052 of receiving object appearance information characterizing visual attributes of the real-world object 1obj1, such as may be derived from a source image 7im1 (FIG. 15). The object appearance information is derived from the appearance of the real-world object 1obj1 within the original source recording. The method further comprises processing the initial composite video sequence using, for example, a diffusion-based generative model 91MLmodel (FIG. 15) to generate an enhanced sequence (step 1053), for example a sequence containing enhanced frames such as 7im10c′ (FIG. 13B) or 7im10d′ (FIG. 14B). This processing comprises guiding the diffusion-based generative model 91MLmodel during generation of the enhanced composite video sequence utilizing information derived from both the initial composite video sequence and the received object appearance information. The generated enhanced composite video sequence exhibits visual attributes consistent with the received object appearance information, while demonstrating improved visual integration between the representations of the real-world object 1obj1 and the depictions of the synthetic environment compared to the initial composite video sequence.

In one embodiment, the initial composite video sequence received in step 1051 is generated by a specific process. This process includes tracking motion 9mvnt (FIG. 1A) associated with the capture of the original source recording relative to the real-world object 1obj1, thereby defining an initial camera motion trajectory. It further includes extracting object representations corresponding to the real-world object 1obj1 from the original source recording, and placing said object representations within a synthetic 3D scene constituting the synthetic environment. Finally, the process includes rendering the synthetic 3D scene containing the placed object representations from viewpoints determined by the initial camera motion trajectory.

In a further embodiment of the method, the improved visual integration demonstrated by the generated enhanced composite video sequence is associated with a reduction of perceived visual inconsistencies. Said inconsistencies may arise from discrepancies between (i) viewpoints determined by the initial camera motion trajectory used for rendering the object representations of object 1obj1 within the initial composite video sequence, and (ii) effective viewpoints from which the real-world object 1obj1 was captured in the original source recording corresponding to said object representations. This reduction of inconsistencies is achieved through an adaptive modification of the visual appearance of the object representations by the diffusion-based generative model 91MLmodel, while maintaining visual attributes consistent with the received object appearance information.

In another embodiment, the improved visual integration demonstrated by the generated enhanced composite video sequence is associated with an enhanced perceived fluidity of camera movement compared to the initial composite video sequence. The enhanced perceived fluidity is achieved by the diffusion-based generative model 91MLmodel, when guided by information from the initial composite video sequence (e.g., 7im10d) and the received object appearance information (e.g., from 7im1), synthesizing frames for the enhanced composite video sequence (e.g., 7im10d′). The synthesized frames collectively depict a modified sequence of viewpoints corresponding to a camera motion trajectory with reduced noise or irregularities compared to the initial camera motion trajectory, while maintaining visual attributes consistent with the received object appearance information for object 1obj1.

In a further embodiment of the method described in the preceding paragraph, the diffusion-based generative model 91MLmodel, when synthesizing the frames that collectively depict the modified sequence of viewpoints, is further guided by the initial camera motion trajectory.

In one embodiment, such as that illustrated by the transformation from initial representation 7im10c (FIG. 13A) to enhanced representation 7im10c′ (FIG. 13B), the improved visual integration is associated with an adaptive adjustment of contrast of the representations of the real-world object 1obj1. This adjustment is performed by the diffusion-based generative model 91MLmodel to better match contrast characteristics of the depictions of the synthetic environment, while preserving visual attributes consistent with the received object appearance information.

In another embodiment, the improved visual integration is associated with an adaptive adjustment of brightness of the representations of the real-world object 1obj1 by the diffusion-based generative model 91MLmodel to better match illumination levels of the depictions of the synthetic environment, while preserving visual attributes consistent with the received object appearance information.

In another embodiment, the improved visual integration is associated with an adaptive adjustment of color composition of the representations of the real-world object 1obj1 by the diffusion-based generative model 91MLmodel to achieve greater color harmony with the depictions of the synthetic environment, while preserving visual attributes consistent with the received object appearance information.

In another embodiment, the improved visual integration is associated with a generation or modification of shadowing, such as shadow 2shadow2 (FIG. 11C), related to the representations of the real-world object 1obj1 by the diffusion-based generative model 91MLmodel. Such modification ensures said shadowing is more consistent with light sources within the depictions of the synthetic environment, while preserving visual attributes consistent with the received object appearance information.

In another embodiment, the improved visual integration is associated with a reduction or modification of glare or specular highlights on the representations of the real-world object 1obj1 by the diffusion-based generative model 91MLmodel, to better align with reflective properties and light sources within the depictions of the synthetic environment, while preserving visual attributes consistent with the received object appearance information.

In another embodiment, the improved visual integration is associated with a generation or enhancement of contact shadows, such as the shadow detail 2shadow2 shown in FIG. 11C, at an interface between the representations of the real-world object 1obj1 and surfaces within the depictions of the synthetic environment. This is performed by the diffusion-based generative model 91MLmodel and improves a sense of grounding of the object 1obj1, while preserving visual attributes consistent with the received object appearance information.

In another embodiment, the improved visual integration is associated with a generation or refinement of diffuse shadows cast by or upon the representations of the real-world object 1obj1 by the diffusion-based generative model 91MLmodel, to more accurately reflect the interplay of light and occlusion within the depictions of the synthetic environment, while preserving visual attributes consistent with the received object appearance information.

In embodiments where the real-world object is a human, such as the human object 1obj1 represented by 7im10d (FIG. 14A), the improved visual integration is associated with an enhancement of perceived human-environment interactivity by the diffusion-based generative model 91MLmodel. This enhancement creates a more natural and contextually appropriate depiction of the human 7im10d′ within the synthetic environment, while preserving visual attributes consistent with the received object appearance information.

In one embodiment of the method described in the preceding paragraph, such as shown in the transformation from 7im10d to 7im10d′, the enhancement of perceived human-environment interactivity comprises an adaptive adjustment of the depicted human's gaze direction by the diffusion-based generative model 91MLmodel. This orients the gaze towards a designated object or area of interest within the depictions of the synthetic environment.

In another embodiment, the enhancement of perceived human-environment interactivity comprises an adaptive modification of the depicted human's pose or subtle body language by the diffusion-based generative model 91MLmodel, to suggest interaction with or reaction to elements within the depictions of the synthetic environment.

In another embodiment, the enhancement of perceived human-environment interactivity comprises a generation or modification of subtle environmental effects on the human representation by the diffusion-based generative model 91MLmodel, such as wind affecting hair or clothing, or splashes from virtual water, consistent with conditions depicted in the synthetic environment.

In another embodiment, the enhancement of perceived human-environment interactivity comprises an adjustment to the depiction of the human's hands or limbs by the diffusion-based generative model 91MLmodel, to suggest interaction with, or plausible proximity to, objects or surfaces within the depictions of the synthetic environment.

In embodiments where the real-world object is a human 1obj1, exhibiting visual attributes consistent with the received object appearance information comprises preserving the human identity of said human as depicted in the original source recording.

In one embodiment, preserving the human identity comprises maintaining recognizable facial features of the human, as shown between the initial representation 7im10d and the enhanced representation 7im10d′.

In another embodiment, preserving the human identity comprises maintaining characteristic body shape and proportions of the human object 1obj1.

In another embodiment, preserving the human identity comprises maintaining recognizable skin tone and texture of the human object 1obj1.

In another embodiment, preserving the human identity comprises maintaining recognizable hairstyle and hair color of the human object 1obj1.

In another embodiment, preserving the human identity comprises maintaining the appearance of clothing and accessories worn by the human object 1obj1 as depicted in the original source recording, unless intentionally modified by the diffusion-based generative model for specific interactive effects.

In another embodiment, preserving the human identity comprises maintaining characteristic gait or movement style of the human object 1obj1, to the extent discernible from the original source recording and not intentionally altered for motion smoothing or pose adjustment.

In one embodiment, the diffusion-based generative model 91MLmodel is trained, as illustrated in FIG. 16, so as to ensure that utilization of the received object appearance information during the guiding of the generation of the enhanced composite video sequence prioritizes the preservation of visual attributes consistent with said object appearance information concurrently with achieving the improved visual integration.

FIG. 17B illustrates one embodiment of a method for training a diffusion-based generative model to enhance video sequences while preserving object identity. In one embodiment, the method comprises, for a plurality of training steps, in step 1061, utilizing a training data tuple. As illustrated in FIG. 16, each Input Tuple comprises (i) an initial composite frame, such as 7im10d or 7im10c; (ii) object appearance information derived from an original source recording, such as from source image 7im1; and (iii) a corresponding target enhanced frame, such as 7im10d′ or 7im10c′. The method further comprises processing, using, for example, a version of the diffusion-based generative model 91MLmodel, the initial composite frame to generate (in step 1062) a predicted frame, wherein said processing is guided by the object appearance information. The method then comprises (in step 1063) calculating a combined loss value. This combined loss value is based on: a reconstruction loss, which measures a difference between the predicted frame and the target enhanced frame; and an identity loss, which measures a difference between visual identity features of the object as depicted in the predicted frame and visual identity features derived from the object appearance information. Finally, the method comprises updating (in step 1064) weights of the diffusion-based generative model 91MLmodel based on the combined loss value.

It is important to note that while FIG. 16 illustrates the training of the diffusion-based generative model 91MLmodel utilizing specific “Input Tuples” (comprising an initial frame, source image, and target frame), the invention is not limited to this specific data structure. The training methodology may encompass a variety of data combinations and learning paradigms. In one embodiment, the model is trained using unsupervised or self-supervised learning, where the system masks out random sections of a single video sequence and tasks the model with reconstructing the missing data (inpainting) while conditioning on the remaining unmasked areas, thereby learning spatiotemporal consistency without explicit “source/target” pairs. In another embodiment, the training utilizes Reinforcement Learning from Human Feedback (RLHF), where the model generates multiple potential enhancements for a composite frame, and human raters (or a secondary “Reward Model” trained on human preferences) rank the outputs based on realism and identity preservation, updating the model to maximize this reward signal. Furthermore, the training input may include additional conditioning modalities beyond images, such as text prompts describing the desired environmental context (e.g., “windy,” “sunset”), depth maps, or skeletal pose graphs, which guide the model's generation process alongside the visual appearance data. These various training configurations all serve the ultimate goal of teaching the model to balance the competing objectives of identity preservation and contextual integration.

Furthermore, while FIG. 16 depicts a training process utilizing a tuple of three specific inputs (initial frame, source image, target frame), this is merely one exemplary configuration. The number and arrangement of inputs provided to the training system 81 may vary significantly depending on the specific model architecture and learning objective. In one embodiment, the training utilizes a paired input structure (2 inputs), comprising only the “Initial Composite” (input) and the “Ground Truth Video” (target), where the identity information is implicitly learned from the ground truth rather than provided as a separate source image. In another embodiment, the input is arranged as a temporal sequence or “volume” of inputs (e.g., 5 consecutive initial frames +1 source identity image), teaching the model to enforce temporal consistency and reduce flicker across multiple frames simultaneously. Alternatively, the information may be disentangled across a larger set of inputs (e.g., 4 or more inputs), where the “source information” is split into separate inputs for “Structure” (e.g., a depth map or segmentation mask) and “Style/Texture” (e.g., a crop of the face), allowing the model to learn these attributes independently. Thus, the term “tuple” as used herein should be understood broadly to encompass any grouped set of training signals, whether they be pairs, triplets, or higher-dimensional tensors, arranged in any order suitable for minimizing the model's loss function.

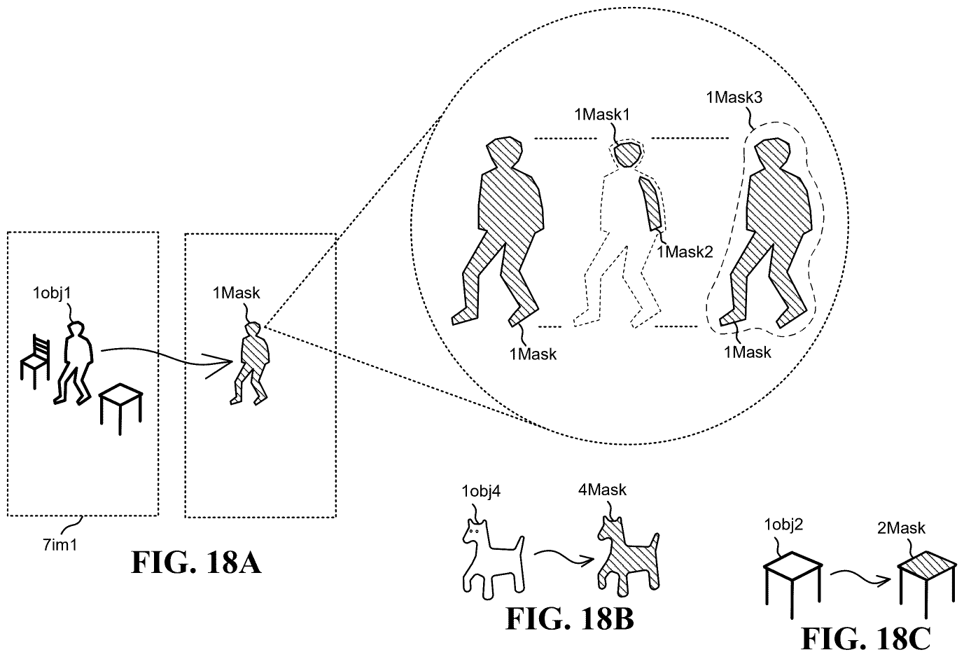

Similarly, the inference system 91 illustrated in FIG. 15 is not limited to the specific two-input configuration shown (receiving 91in1 initial composite and 91in2 source image). The system may be capable of receiving and processing any number of inputs necessary to guide the generative process. In various embodiments, the input interface may receive a single combined input (e.g., the initial composite frame with the source appearance data embedded as metadata or a concatenated tensor channel), or a plurality of distinct inputs (e.g., 3, 4, or more). For example, in addition to the initial frame and source image, the system may receive auxiliary inputs such as the masking constraints described in FIG. 18A (1Mask, 1Mask1, etc.), environmental maps (such as a High Dynamic Range (HDR) light map of the synthetic scene), textual descriptors (e.g., “looking left,” “smiling”), or control signals. These additional inputs act as further conditioning layers for the diffusion-based generative model 91MLmodel, providing granular control over the generated output 91out. Thus, the system architecture is flexible and scalable, capable of ingesting a wide array of multimodal data to achieve the desired identity-preserving enhancement.

Furthermore, while the “diffusion-based generative model” (91MLmodel) is one embodiment with high fidelity, the invention is not strictly limited to diffusion architectures. The generative enhancement and identity preservation described herein may be implemented using other generative neural network architectures capable of conditional image synthesis. These include, but are not limited to, Generative Adversarial Networks (GANs), Variational Autoencoders (VAEs), Vision Transformers (ViTs), or Consistency Models. Similarly, the “rendering” aspect need not be traditional rasterization; the “synthetic environment” could be represented as a Neural Radiance Field (NeRF) or a Gaussian Splatting scene. In such a case, the “generative enhancement” might involve optimizing the spherical harmonics or density functions of the splats representing the object to match the lighting of the splats representing the background, rather than processing 2D pixels.

In some embodiments where the generative model (e.g., 91MLmodel) is implemented as a Diffusion Model (such as a Latent Diffusion Model or Video Diffusion Model), the training process may comprise a specific forward noising process and a reverse denoising process, distinct from direct pixel-to-pixel regression. The Forward Process (Noise Injection): Unlike standard supervised learning where the model directly maps the “Initial Composite Frame” to the “Target Enhanced Frame,” the diffusion training phase utilizes the “Target Enhanced Frame” (Ground Truth) as the starting point X0. The system applies a noise schedule (e.g., Gaussian noise) to X0 over a series of random time steps t, producing a noisy latent representation Xt. This effectively destroys the high-frequency details of the target identity while preserving the semantic layout. The Conditional Denoising Objective: The model 91MLmodel is trained to reverse this process (i.e., predict the added noise or the velocity) to recover X0 from Xt. Crucially, this denoising process is conditioned on the “Initial Composite Frame.” The “Initial Composite Frame” (the crude 3D billboard in the synthetic scene) acts as a spatial control signal (similar to a depth map, Canny edge map, or “ControlNet” input). It is injected into the model via: Concatenation: Concatenating the composite frame latents with the noisy target latents; and/or Cross-Attention: Using the composite frame features to guide spatial attention layers. Therefore, the “prediction” described in previous sections refers to the model predicting the noise residual required to transform the random noise back into the high-fidelity target, strictly adhering to the spatial constraints (pose, lighting, geometry) provided by the “Initial Composite Frame” and the identity constraints provided by the reference images. Temporal Consistency for Video Generation: To ensure temporal coherence and prevent flickering across the video sequence, the model may be operative to process blocks of frames (e.g., tuples or sliding windows of N frames) simultaneously rather than as independent images. Temporal Layers: The architecture includes Pseudo-3D Convolutions or Temporal Attention Modules inter-spaced between spatial layers. These modules learn motion dynamics by attending to features at the same spatial location across adjacent time steps t−1, t, t+1. Joint Training: The training loss is computed over the entire frame block, penalizing temporal discontinuities. This ensures that the “Identity-Preserving Enhancement” remains consistent as the object moves or rotates within the synthetic scene.

Generalization of Processing Architecture (Distributed, Hybrid, and Edge Configurations): It is imperative to clarify that the computational workload described in conjunction with FIGS. 1B, 1C, and 15 is not statically bound to a single hardware entity. The invention anticipates a highly flexible, distributed computing architecture where the specific sub-processes (Tracking, Masking, Rendering, and Generative Enhancement) can be dynamically allocated across a spectrum of devices based on network availability, battery constraints, and processing power.

In one “Thin Client” embodiment, the user device 8device1 functions primarily as a capture and display terminal. Here, the device transmits raw or lightly compressed video streams and sensor data (IMU, Gyroscope) to a remote server cluster (e.g., 8server1/8server2) via a high-bandwidth connection (e.g., 5G or Wi-Fi 6). The cloud infrastructure performs the heavy lifting: extracting the object, calculating the SLAM tracking, rendering the synthetic scene, and executing the large-scale diffusion inference. This configuration allows for cinema-quality generative enhancement on low-power end-user devices, leveraging the virtually unlimited VRAM and compute resources of cloud GPUs to run the largest, most coherent diffusion models without draining the user's battery.

Conversely, in a “Privacy-First” or “Offline” embodiment, the entire pipeline is compressed to run locally on the edge device 8device1. Utilizing modern System-on-Chip (SoC) architectures with dedicated Neural Processing Units (NPUs), the system employs quantized models (e.g., INT8 quantization) and optimized lightweight architectures (e.g., MobileNet-based extraction, Distilled Diffusion models). In this scenario, the “Tracking” and “Mask Generation” (FIG. 18A) happen instantaneously on the CPU/GPU, while the NPU handles the generative enhancement frame-by-frame. This configuration ensures zero network latency, making it ideal for real-time AR applications, and guarantees user privacy since biometric data (the user's face) never leaves the local hardware.

In a “Hybrid” embodiment, the workload is split based on latency sensitivity. Latency-critical tasks, specifically Tracking and Mask/Matte Generation, are executed locally on 8device1 to ensure the object “sticks” to the camera movement without lag. The device then transmits the extracted “flat surface” texture, the tracking metadata, and the generated masks to the cloud. The cloud server executes the Generative Enhancement, which requires heavy computation to fix lighting and gaze, and streams the enhanced frames back to the device. This split allows for responsive motion tracking (local) combined with photorealistic lighting integration (cloud).

The concept may also support a Cascaded or “Preview-Final” architecture. In this workflow, the user device 8device1 runs a lightweight “Proxy Model” (e.g., a fast GAN or simple color-correction filter) to show the user a real-time, approximate preview of the integration while they are recording. Simultaneously, the high-fidelity data is queued for asynchronous processing in the cloud (or on the device in the background). Once the recording is complete, the full-scale Diffusion Model processes the sequence to generate the “Final Cut” with perfect shadows, gaze correction, and physics-based hair simulation. This provides the user with immediate feedback during capture while delivering professional-grade results for the final output.

Furthermore, the distribution may occur over a local area network (LAN) or tethered connection. For example, a wearable device (such as AR glasses) may capture the video and tracking data, but offload the processing to a paired smartphone, a local gaming console, or a desktop PC on the same Wi-Fi network. The paired “host” device performs the masking and generative inference and streams the result back to the wearable display. This allows for high-fidelity generative AR experiences on lightweight wearable hardware by leveraging the compute power of local, nearby infrastructure.

In a strictly “Cloud-Only” embodiment, the mobile device 8device1 operates exclusively as a networked sensor array with minimal logic. In this configuration, the device performs no local tracking, extraction, or rendering. Instead, it continuously streams raw or minimally encoded video data, synchronized with raw telemetry data from the inertial measurement unit (accelerometer and gyroscope), directly to the backend infrastructure (8server1). The cloud server assumes full responsibility for the entire pipeline: it executes the Simultaneous Localization and Mapping (SLAM) algorithms on the raw telemetry data to reconstruct the camera path 9mvnt; it runs the heavy segmentation models to extract the object 1obj1 and generate masks; and it performs the 3D scene rendering and the final diffusion-based generative enhancement 91MLmodel. This architecture allows for the deployment of the invention on ultra-low-power devices or legacy hardware that lacks the processing capability for even basic tracking, effectively turning any connected camera into a portal for high-end generative reality content.

It is further emphasized that while the present disclosure describes a comprehensive end-to-end workflow encompassing motion tracking, object extraction, flat-surface projection, and final generative enhancement, the invention is fundamentally modular. The generative enhancement subsystem (System 91, FIG. 15) may be capable of operating as a standalone post-processing unit. In such an embodiment, the “initial composite video sequence” is “given” to the system as a pre-existing input, rather than being generated by the tracking and rendering modules. This input composite may originate from any external source, such as a traditional chroma-key (green screen) compositor, a legacy visual effects pipeline, or a standard 3D CGI render. In this standalone configuration, the diffusion-based generative model 91MLmodel performs the identity-preserving visual integration (fixing lighting, correcting gaze, generating contact shadows) on the provided footage without requiring access to the original sensor telemetry or tracking data. This decouples the generative enhancement capability from the capture hardware, enabling the invention to serve as a universal “finishing engine” for any composite video content, regardless of its origin.

However, within the context of the full end-to-end workflow, the final generative enhancement step may assume a critical role in correcting the inevitable “photomontage” degradation. The upstream processes (tracking, 2D extraction, and flat-surface embedding) efficiently place the object into the scene, but inherently produce a composite that looks like a collage or a cut-out. This “photomontage” effect may be characterized by unnatural sharp edges, mismatched lighting directions, and the tell-tale “flatness” of a 2D plane moving in 3D space. The generative model 91MLmodel acts as the essential unifying layer that resolves these artifacts. By leveraging the tracking data and masking constraints, it doesn't just filter the image; it actively resynthesizes the boundary between the real and the synthetic. It “re-inflates” the flat subject with volumetric shading, harmonizes the light interactions, and smooths the jarring perspective shifts, effectively elevating the output from a rough 2D montage to a cohesive, photorealistic 3D video sequence, while preserving identities.

FIG. 18A illustrates one embodiment of generating various masking constraints for a human object 1obj1 appearing in an image 7im1. These masks serve as spatial control signals for the diffusion-based generative model, defining not just where the object is, but how the model is permitted to modify specific regions. As shown, the system extracts the object 1obj1 and generates a foundational global mask 1Mask, which defines the strict geometric silhouette of the person. In scenarios requiring rigorous fidelity, 1Mask acts as a hard spatial lock, restricting the generative model to photometric adjustments (lighting, color) only within these specific pixels.

To enable the advanced identity-preserving articulation described herein, the system may generate semantic sub-masks, such as 1Mask1 and 1Mask2. The mask 1Mask1 isolates the head and face region. Crucially, 1Mask1 is defined as a region subject to a “selective constraint.” While it enforces strict preservation of identity-defining features (such as bone structure and likeness), it is simultaneously designated as an articulable region permitting internal structural deviations. This allows the generative model to modify the subject's expression or adjust gaze direction (as seen in the transition from FIG. 14A to 14B) to match the context of the synthetic scene, without breaking the viewer's recognition of the subject's identity. Similarly, 1Mask2 identifies a limb (an arm) as an articulable region with a higher degree of allowable geometric variance, permitting the model to reposition the limb to interact with the environment while maintaining the texture and clothing style of the original object.

Furthermore, FIG. 18A illustrates an optional soft or expanded boundary mask 1Mask3. Unlike the strict silhouette of 1Mask, the expanded mask 1Mask3 extends beyond the original geometry of the object. This creates a transition zone or “buffer” that allows the generative model to hallucinate or modify pixels outside the original strict geometry in response to the synthetic background. This flexibility is essential for realistic integration, allowing for effects such as wind blowing hair or clothing outside the original contours, or the generation of immediate contact occlusion and light wrap-around effects that blur the line between the object and its new environment.

The deployment of these various masking configurations may address a fundamental technical challenge in generative video enhancement: the tension between Identity Preservation (which typically requires rigid adherence to source geometry) and Contextual Integration (which often requires geometric modification). A single binary mask is often insufficient to resolve this tension because different parts of a real-world object require different “degrees of freedom” when integrated into a synthetic scene. Therefore, the system may be configured to utilize these masks (1Mask, 1Mask1, 1Mask2, 1Mask3) not merely as pixel-selection tools, but as logical constraint layers or a Guidance Map. This allows the system to enforce a “Strict Preservation Protocol” on identity-defining regions (like the jawline or nose within 1Mask1) while simultaneously enabling an “Adaptive Protocol” on interaction-defining regions (like the arm in 1Mask2 or hair in 1Mask3).

In one embodiment representing a “Pure Photometric Mode,” the system utilizes the foundational mask 1Mask as a strict geometric lock. This mode is particularly useful in scenarios where the original motion of the object is perfect, but the lighting is mismatched. Here, the generative model 91MLmodel (FIG. 15) is constrained to modify only the pixel values (e.g., brightness, contrast, color grading) within the boundaries of 1Mask, while the boundary itself remains immutable. This ensures that the silhouette of the object remains exactly as captured in the source recording 7im1, providing maximum fidelity at the cost of limited interactivity.

In contrast, embodiments utilizing the sub-masks 1Mask1 and 1Mask2 enable a “Structural Adaptation Mode.” During the inference stage (System 91, FIG. 15), these masks provide spatially-variant instructions to the diffusion model. For example, when the system detects a need for gaze correction (as in FIG. 14B), the region defined by 1Mask1 acts as a Selective Constraint. The model is authorized to generate new pixel structures for the eyes and pupils to align with a target vector in the 3D scene, provided that the surrounding facial embeddings (the “identity features”) remain consistent with the source. Simultaneously, 1Mask2 acts as a Semantic Anchor for the limb. If the synthetic environment contains a surface (like a table) that physically conflicts with the original arm position, the model utilizes the high variance allowance of 1Mask2 to hallucinate a new, anatomically plausible arm position that resolves the physics of the scene, prioritizing the semantic logic of the interaction over the pixel-perfect accuracy of the original limb position.

The expanded mask 1Mask3 may faciliate a “Generative Blending Mode.” In this configuration, the area between the strict hull (1Mask) and the expanded boundary (1Mask3) is treated as a high-uncertainty buffer. During inference, the generative model is permitted to perform generative outpainting in this zone. This allows for the generation of environmental effects that physically bridge the gap between the real object and the synthetic world, such as generating shadows that wrap around the object, simulating cloth fluttering in a virtual wind, or creating ambient occlusion darkening where the object contacts a virtual wall. Without this expanded buffer, the object might appear as a sharp “cut-out”; with it, the boundaries become organically integrated.

In one embodiment, the masking concepts are intrinsic to the training stage (System 81, FIGS. 16 and 17B). The diffusion-based generative model 91MLmodel may not inherently know how to treat a face differently from an arm; it may be taught this distinction via the training data tuples. In one embodiment, the training system 81 employs a spatially-weighted loss function utilizing these masks.

Identity Weighting: For pixels falling within 1Mask1, the system may apply a high penalty weight to the Identity Loss component (e.g., measuring facial feature vectors). This teaches the model that altering bone structure is “expensive” and should be avoided.

Geometric Weighting: For pixels falling within 1Mask2, the system may lower the penalty weight for Reconstruction Loss (spatial matching). This teaches the model that the spatial position of a limb is “cheap” to move, provided the texture remains consistent.

Adversarial Weighting: For the buffer zone in 1Mask3, the system may prioritize Adversarial Loss (realism) over Reconstruction Loss, effectively teaching the model that generating realistic details (like loose hair) that weren't in the original video is a valid strategy for achieving high-quality integration.

In some embodiments, these masks are combined into a single, multi-channel Guidance Map fed into the model. For instance, a first channel may define the hard silhouette (1Mask), a second channel may define the identity-lock region (1Mask1), and a third channel may define the environmental expansion zone (1Mask3). The generative model utilizes internal attention mechanisms (such as Cross-Attention layers or ControlNet adapters) to modulate its denoising process based on the values in these channels. This architecture allows the system to handle complex, composite requirements, such as fixing the lighting on a face, moving the eyes to look left, repositioning an arm to rest on a chair, and blowing the hair in the wind, all within a single inference pass, ensuring a cohesive and identity-preserved output.

Furthermore, the “Selective Constraint” applied to the head region via 1Mask1 may enable the generative model to perform learned 3D-aware articulations. While the input 7im1 is a 2D image, the diffusion-based generative model 91MLmodel, having been trained on diverse datasets of human motion and varying perspectives, possesses an implicit understanding of 3D facial geometry. When the system requires a significant change in gaze or head orientation (e.g., turning the head slightly to face a virtual speaker), the model utilizes the 1Mask1 region to generate a “novel view” synthesis of the face. Unlike a simple 2D warp which might distort facial features, the model hallucinates the occluded side of the face or rotates the nose geometry in a manner consistent with 3D perspective laws. Crucially, because of the strict Identity Loss weighting applied to this region during training, the model performs this 3D rotation while rigorously constraining the synthesized features, such as the profile of the nose or the set of the jaw, to match the biometric identity of the source subject 1obj1, effectively simulating a 3D rotation of the real person rather than a generic avatar.

The generation of these various masking constraints (1Mask, 1Mask1, 1Mask2, 1Mask3) may be achieved through several techniques utilizing distinct or combined technological approaches. In one embodiment, the foundational global mask 1Mask is generated using a semantic segmentation neural network trained to identify and isolate specific object classes, such as “person,” from the background of the original source recording. This network analyzes the RGB pixel data of the source image 7im1 and outputs a binary alpha matte defining the precise pixel-level silhouette of the object 1obj1. Alternatively, if the original source recording was captured using a device with depth-sensing capabilities (such as LiDAR or a Time-of-Flight sensor, as shown in 8device1), the mask 1Mask can be generated or refined using depth disparity data, allowing for accurate separation of the object from the background even in complex lighting conditions where visual boundaries are ambiguous.

The semantic sub-masks 1Mask1 (Face/Head) and 1Mask2 (Limbs) may require a more granular understanding of the object's topology. In one embodiment, these masks are generated utilizing a pose estimation model. The system detects key anatomical landmarks (keypoints) on the object 1obj1, such as the eyes, nose, shoulders, elbows, and wrists. The system then generates 1Mask1 by defining a region of interest (ROI) or a convex hull around the facial keypoints (eyes, nose, mouth), effectively isolating the identity-defining region. Similarly, 1Mask2 is generated by defining a segmentation blob connecting the shoulder, elbow, and wrist keypoints, logically isolating the arm structure. This landmark-driven approach ensures that the “selective constraints” are automatically and dynamically mapped to the correct anatomical regions as the object moves through the video sequence.

In another embodiment, the expanded mask 1Mask3 is generated through morphological image processing operations. The system takes the strict binary hull 1Mask and applies a dilation operation (expanding the white region by a predetermined number of pixels) to create a larger footprint. The difference between the dilated mask and the original mask constitutes the “buffer zone” or “transition region.” In more advanced embodiments, the extent of this dilation is adaptive; a secondary machine learning analysis of the object's texture might detect “fuzzy” edges like hair or loose clothing and automatically increase the dilation radius in those specific areas to allow for greater generative flexibility, while keeping the dilation minimal around rigid areas like shoes.

Furthermore, a specialized Identity-Parsing Network may be employed to generate high-fidelity sub-masks. This network is specifically trained to segment different parts of a human face and body (parsing the image into labels such as “skin”, “hair”, “shirt”, “pants”). The system can then logically combine these semantic labels to form the constraint masks. For instance, the “skin” pixels of the face could be assigned to the strict identity-preservation layer (1Mask1), while the “shirt” and “pants” pixels could be assigned to a layer permitting higher variance in lighting and folding (1Mask2), thereby automating the creation of the multi-channel “Guidance Map” without manual user intervention.

FIG. 18B illustrates one embodiment of generating a masking constraint for a non-human animate object 1obj4, such as a dog or other pet. Similar to the human examples, the system generates a global mask to define the object's hull. However, the internal segmentation utilizes a specialized 4Mask designed for animal morphology. This mask might differentiate between the animal's core body (requiring texture preservation to maintain the specific coat pattern and identity of the pet) and articulable regions such as the tail, ears, or legs. For example, the “Selective Constraint” applied via 4Mask could authorize the generative model to modify the position of the tail (e.g., to simulate wagging in a happy scene) or the orientation of the ears (e.g., perked up in an alert scene) to match the context of the synthetic environment, while strictly preserving the unique markings and facial structure that identify the specific animal. This demonstrates that the principles of identity-preserving articulation are applicable to any animate subject where “likeness” and “behavior” must be balanced.

FIG. 18C illustrates one embodiment of generating a masking constraint for an inanimate object 1obj2, such as a chair or vehicle. While inanimate objects do not have “identity” in the biological sense, they possess specific structural integrity that must be maintained. Here, the system generates a mask 2Mask that may distinguish between rigid structural components (e.g., the wooden legs and frame of a chair) and potentially deformable or interactive components (e.g., a cushion or fabric cover). In this embodiment, the “Selective Constraint” might enforce absolute geometric rigidity on the legs (to prevent the generative model from warping the wood like rubber), while permitting photometric adjustments or even slight geometric deformation on the cushion (to simulate the weight of a virtual character sitting on it). This application of the masking logic ensures that even inanimate objects integrate realistically into the physics of the synthetic scene without losing their material definition or structural logic.

To demonstrate a comprehensive operation, an exemplary end-to-end workflow is described wherein a real-world object 1obj1, specifically a user wearing a textured denim jacket and distinctive eyeglasses, is integrated into a high-contrast synthetic environment 2model representing a “Neon City” street scene at night. The workflow initiates with the capture phase, where the smartphone 8device1 records a source video 7im1 of the user walking through a brightly lit, white-walled room. The tracking sub-system 8track records the camera motion 9mvnt, and the image processing system extracts the user to create a sequence of flat-surfaced representations 2FLAT. These representations are placed into the synthetic “Neon City” scene 2model based on the tracked trajectory. At this intermediate stage, the resulting composite video exhibits significant “photomontage” degradation: the user appears visually disconnected from the environment due to the flat, bright indoor lighting of the source recording clashing with the dark, colorful directional lighting of the virtual street; the user appears to lack volume; and the user's gaze is directed forward (as in 7im10d) rather than interacting with a virtual autonomous drone flying to their left in the synthetic scene.

To resolve these artifacts while strictly maintaining the user's likeness, the system may generate a multi-layered guidance map utilizing the masking constraints illustrated in FIG. 18A. A sub-mask 1Mask1 is generated to isolate the user's head, specifically identifying rigid identity features including the zygomatic arches, the nasal bridge, and the specific geometric rim of the user's eyeglasses. The system assigns a strict “Preservation Protocol” to these regions, ensuring that the diffusion-based generative model 91MLmodel is mathematically constrained from altering the shape of the face or the design of the glasses. Simultaneously, the region corresponding to the user's eyes within 1Mask1 is designated for “Adaptive Modification,” and the region corresponding to the denim jacket is segmented (e.g., via 1Mask2) to preserve the fabric's weave texture while allowing photometric updating. An expanded mask 1Mask3 is generated around the user's silhouette to define a buffer zone for environmental blending.

The diffusion-based generative model 91MLmodel then executes the enhancement process, conditioned on the “Neon City” environment and the guidance map. First, the model addresses photometric consistency: it drastically alters the pixel values of the denim jacket, darkening the fabric to match the ambient night levels while adding cyan and magenta specular highlights to the shoulders, corresponding to virtual neon signs in the synthetic scene. Crucially, the model preserves the high-frequency details of the denim weave identified by the preservation protocol, preventing the jacket from looking like a flat texture map. Second, the model addresses volumetric consistency: utilizing the buffer zone of 1Mask3, the model generates a “light wrap” effect where the virtual neon light bleeds around the edges of the user's hair and clothing, and hallucinates a directional contact shadow 2shadow2 on the virtual pavement, effectively “re-inflating” the flat surface 2FLAT so it appears to occupy physical 3D space.

Finally, the model may address contextual interactivity through geometric articulation. Recognizing the presence of the virtual drone to the left of the user, and authorized by the adaptive constraint on the eye region of 1Mask1, the generative model 91MLmodel resynthesizes the pixels of the pupils and iris to shift the user's gaze toward the drone (resulting in the enhanced state 7im10d′). This geometric alteration is performed with high precision, ensuring that while the gaze direction changes, the surrounding eyelids, skin tone, and the position of the eyeglass frames remain pixel-perfectly consistent with the source image 7im1. The resulting output video depicts the user walking naturally through the cyberpunk city, lit by its environment and reacting to its elements, yet remaining instantly and unmistakably recognizable as the specific individual from the source recording.

In an alternative embodiment of the workflow described above, the system is configured to permit “Stylistic Transformation” while maintaining “Biometric Preservation.” In this scenario, the guidance map is adjusted to alter the constraints applied to the user's clothing and accessories. While the mask 1Mask1 continues to strictly enforce preservation of the user's biological features (skin tone, facial structure, hair), the constraints on the inanimate elements, specifically the denim jacket and the eyeglasses, are relaxed or redefined. The sub-mask corresponding to the eyeglasses is flagged with a “Generative Replacement” protocol, while the sub-mask corresponding to the jacket (e.g., 1Mask2) is flagged for “Texture Transfer.”

Consequently, when the diffusion-based generative model 91MLmodel processes the composite, it performs a radical transformation on these specific elements to better suit the “Neon City” aesthetic. The model replaces the user's original eyeglasses with a pair of futuristic, glowing visors generated to fit the user's face, utilizing the spatial data from the original frames only as an anchor point for position. Simultaneously, the model transmutes the material of the user's jacket from denim to a reflective cybernetic armor or illuminated leather, utilizing the “buffer zone” of the mask to generate new geometric extrusions (such as shoulder pads) that extend beyond the original silhouette. Throughout this transformation, the user's face remains strictly locked to the source image 7im1. The result is a composite where the user appears to be wearing a digital costume appropriate for the virtual world, yet the person inside the costume is undisputedly the original user, demonstrating the system's capability to selectively decouple stylistic identity from biological identity based on user-defined or context-defined parameters.

In a further variation of the “Neon City” scenario, the system may be authorized to perform “Deep Articulation” involving gross geometric rotation of the user's head. Unlike the previous example where only the pupils shifted, here the user's interaction with the virtual drone requires a significant physical reaction, such as turning the head 30 degrees to the left. The system utilizes the selective constraint on the head mask 1Mask1 to permit this rotation. The generative model 91MLmodel, leveraging its learned understanding of 3D human anatomy, resynthesizes the entire facial region to depict the new angle. This process involves “generative inpainting” to hallucinate the previously occluded right side of the cheek and ear which are now visible due to the turn, and “generative occlusion” to hide the left side of the face that rotates away from the camera. Crucially, despite generating substantial new pixel data to depict this novel angle, the model remains bound by the deep feature loss associated with the source identity 7im1. This ensures that the newly hallucinated profile view, the shape of the nose in profile, the curve of the cheekbone, and the ear structure, is statistically consistent with the frontal view captured in the source recording, effectively simulating a volumetric rotation of the specific user's head without access to a 3D scan.

Additionally, the system may execute “Limb Articulation” to resolve physical inconsistencies between the user and the synthetic environment. In the “Neon City” scenario, the tracked trajectory might place the user close to a virtual railing or balustrade. If the user's arm in the original source recording 7im1 is hanging naturally at their side, it might visually clip through the virtual railing, breaking the illusion. To correct this, the system designates the arm region (defined by 1Mask2) as fully articulable. The generative model 91MLmodel repositions the arm, bending it at the elbow and raising the hand to appear as if the user is resting their hand on the railing. This transformation requires the model to generate new geometry for the bent elbow and foreshortened forearm, as well as accurate contact shadows where the hand meets the railing. Throughout this articulation, the model preserves the texture and material properties of the user's sleeve (or the cybernetic armor from the previous embodiment), ensuring that the moved arm looks materially identical to the rest of the user's attire.

While the preceding examples describe the use of explicit, multi-layered guidance maps to direct the generative process, in another embodiment, the system achieves these transformations utilizing only a basic, global area identification mask 1Mask encompassing the entire person. In this “Implicit Decision Mode,” the diffusion-based generative model 91MLmodel is trained to autonomously infer the optimal balance between preservation and modification based on the semantic context of the scene. The model may utilize an internal attention mechanism (e.g., Cross-Attention layers trained on extensive datasets of human-scene interaction) to self-segment the object. Upon detecting the virtual drone, the model internally calculates an “attention spike” in the eye region and automatically decides to shift the gaze, recognizing that eye direction is a mutable state attribute. Simultaneously, upon detecting the high-contrast lighting of the “Neon City,” it automatically decides to re-shade the clothing while preserving the high-frequency identity features of the face, having learned during training that facial structure is a rigid invariant while illumination is a flexible variable. In this embodiment, the decision of “in which way to treat and preserve identity” is delegated entirely to the model's learned discretion, allowing for complex, context-aware enhancements without the need for granular manual masking or pre-defined constraint protocols.

Furthermore, the system may augment or supersede the masking constraints by injecting semantic textual instructions into the generative pipeline. In one embodiment, these instructions are generated automatically by a “Reasoning Module” (e.g., a Large Language Model or Vision-Language Model) that analyzes the context of the synthetic scene and the source object. For example, the Reasoning Module might analyze the “Neon City” scene, detect the virtual drone, and automatically inject a text prompt such as “A person looking at a flying drone, cyberpunk lighting, highly detailed face” into the diffusion model's conditioning layer. In another embodiment, the system provides a selection interface allowing a human operator to manually input or select prompts. The operator might select a style modifier such as “Cinematic Lighting” or an action modifier such as “Holding a virtual coffee cup.” These textual instructions act as high-level control signals that guide the generative model's denoising process, working in conjunction with the spatial masks (or instead) to direct the specific artistic or behavioral outcome of the enhancement (e.g., ensuring the generated “looking” action targets the drone specifically).

In a further variation, the system may address temporal artifacts. In the source recording, the user's movement might be jerky or contain camera shake. The generative model, configured with temporal attention modules (e.g., as a Video Diffusion Model), processes the sequence not just frame-by-frame, but as a volumetric block of time. It utilizes this temporal context to perform “Generative Stabilization.” The model hallucinates a smoother trajectory for the user's center of mass, effectively re-animating the walking gait to appear fluid and cinematic, dampening the jitter from the handheld capture. This temporal awareness also ensures that the generated “futuristic visor” or “cybernetic armor” remains consistent in shape and texture across all frames, preventing the “flickering” often seen in frame-by-frame generative styling.

The system may also simulate complex physical interactions via generative synthesis. If the “Neon City” scene depicts heavy rain, the system automatically modifies the user's appearance to match. The generative model alters the specular roughness of the jacket to simulate wet fabric, adds procedural water droplets running down the face (while preserving identity), and generates splash particles where the user's feet contact the wet virtual pavement. This variation demonstrates the model's ability to act as a “Neural Physics Engine,” hallucinating physically plausible environmental consequences (wetness, splashes) directly onto the video pixels without requiring a traditional fluid simulation.

In a scenario where the source recording contains multiple users (e.g., two friends walking together), the system may create separate guidance maps for each individual. The generative model then performs “Relational Harmonization.” It not only integrates each user into the background but also ensures they are consistent with each other. If User A is standing closer to a red neon sign, the model casts a red rim light onto User B's face, simulating the light bouncing off User A. Furthermore, if the users are talking, the model utilizes the “Adaptive Protocol” on their faces to synchronize their gaze direction, ensuring they appear to be looking at each other, creating a coherent multi-actor scene from a potentially disjointed source recording.

Finally, the “Neon City” example can be extended to pure artistic abstraction. The user may select a global style filter, such as “Oil Painting” or “Voxel Art.” The generative model utilizes the masking constraints to apply this style selectively. It might render the background and the user's clothing in heavy, abstract brushstrokes, but maintain a “High-Fidelity” constraint on the user's eyes and mouth. This creates an effect where the world is stylized art, but the performance and identity of the actor remain photorealistic and emotive, demonstrating the system's utility for creative stylization in animation and film production.

In a further embodiment, the system is configured to maintain identity consistency across temporal discontinuities or significant occlusions. Standard frame-by-frame diffusion models may “forget” or hallucinate inconsistent details when a subject re-emerges after being blocked by a foreground object. To counter this, the system implements a “Latent Identity Bank.” When the image processing sub-system extracts the object 1obj1, it generates a persistent, high-dimensional feature vector (embedding) representing the subject's biometric signature. This vector is stored in memory 91mem. When the generative model 91MLmodel encounters a frame where the user is partially occluded (e.g., walking behind a virtual pillar in the “Neon City”) or turning away from the camera, it queries the Latent Identity Bank. This allows the model to “inpaint” the missing or re-emerging features, such as the specific shape of the ear or the profile of the nose, by retrieving the information from the bank rather than guessing based solely on the current frame. This ensures that the user's identity remains stable and consistent, even during complex interactions where they enter and exit the camera's view.

The concept of identity preservation may be further expanded to include Audio-Visual synchronization. In scenarios where the user interacts verbally within the synthetic environment (e.g., talking to a virtual avatar), the user's original lip movements in the source video 7im1 may not match the intended dialogue of the scene (or may be non-existent if the user was silent). In this variation, the system receives an audio track as an additional input. The diffusion-based generative model utilizes the face mask 1Mask1 as a target for “Generative Dubbing.” The model resynthesizes the lower face region (lips, jaw, cheeks) to articulate phonemes corresponding to the audio track. Critically, this is not a generic lip-sync; the model is constrained by the Identity Loss to ensure that the shape of the lips, the texture of the skin around the mouth, and the specific dental geometry remain true to the user's identity while forming new words. This allows for the generation of “translated” or “dubbed” videos where the user appears to speak a different language fluently, while maintaining perfect biometric realism.

Furthermore, the system may be capable of preserving identity even when the object is viewed through complex synthetic optics. If the “Neon City” scene includes a rain-streaked glass window or a curved reflective surface (like a motorcycle helmet visor) between the virtual camera and the user, the generative model must render the user's image as distorted. In this embodiment, the system calculates the expected optical distortion map based on the 3D scene geometry. The generative model 91MLmodel is then tasked with generating the user's face 1obj1 as seen through this distortion. The model utilizes the guidance map to enforce identity constraints in the “un-distorted” latent space, ensuring that even though the final pixels are warped by refraction or reflection, the viewer still cognitively recognizes the subject. This effectively creates a “volumetric projection” of identity, allowing the user to be reflected in virtual mirrors or seen through virtual water while remaining unmistakably themselves.

Finally, the “Selective Constraint” mechanism may allow for “Semantic Identity Interpolation.” In certain applications (e.g., gaming or social media), a user may wish to appear as an “older” or “idealized” version of themselves. The system can accept a high-level semantic modifier (e.g., “Age: +20 years” or “Fitness: High”). The generative model utilizes the masking constraints to apply these modifiers selectively. For example, it might deepen nasolabial folds or add texture to the skin (aging) within the face mask 1Mask1, while strictly preserving the underlying cranial structure and eye distance (the rigid identity metrics). This allows the system to generate a prediction of the user's future appearance or a stylized variation, maintaining the core “truth” of the user's identity while logically extrapolating specific attributes to fit a narrative or aesthetic requirement.

In a specific technical implementation embodiment, the diffusion-based generative model 91MLmodel may employ a Dual-Stream or Reference-Attention architecture to ingest the object appearance information. Rather than simply concatenating the source image with the initial composite, the system may utilize a dedicated “Semantic Reference Encoder.” This encoder extracts a high-dimensional feature vector (embedding) representing the semantic and biometric identity of the object 1obj1. These embeddings may be injected into the main denoising neural network via Cross-Attention Layers. Specifically, the spatial features of the initial composite video frame serve as the “Query” (Q) matrices in the attention mechanism, while the identity embeddings from the source image serve as the “Key” (K) and “Value” (V) matrices. This architectural choice forces the generative process to mathematically construct the output pixels by “attending” to the identity features of the source, ensuring that the generated texture is a reconstruction of the specific user's features rather than a generic generation.

In one embodiment, to operationalize the masking constraints at a deep network level, the system may employ a Spatial Adapter architecture comprising parallel neural network branches. In this embodiment, the guidance map (comprising the various masks) is not merely a loss penalty but a direct input into a parallel branch. This branch extracts spatial feature maps from the masks and injects them into the skip-connections or intermediate blocks of the main generative network via zero-initialized convolution layers. This mechanism allows the “Selective Constraints” to bypass the high-level semantic abstractions of the model and directly influence the spatial distribution of pixels. By modulating the weights of these injection layers, the system can dynamically control the “strength” of the geometric lock, effectively turning the “Preservation Protocol” into a learnable network parameter that dictates exactly how much the generated output is allowed to deviate spatially from the input mask.

In one embodiment, the process of “correcting lighting while preserving geometry/identity” is technically achieved through Stochastic Differential Editing or image-to-image translation within a latent space. The system encodes the initial “photomontage” composite into a compressed latent representation. Crucially, instead of starting the generation from pure random noise, the system performs a Forward Diffusion process to add a calculated amount of noise to the latent representation, resulting in a noisy latent at a specific timestep t. The value of t (representing the “Denoising Strength”) is a critical hyperparameter derived from the guidance map.

For regions requiring Strict Preservation (e.g., the face), t is set to a low value, meaning the latent representation retains most of its original spatial structure and the model only “denoises” the fine-grain lighting details.

For regions allowing Articulation or Environmental Blending (e.g., the limbs or mask buffer), t is set to a higher value, effectively destroying more of the original structure and forcing the model to regenerate new, contextually appropriate geometry during the reverse diffusion process.

In one embodiment, regarding the training of the model, the “Combined Loss Value” is computed using a multi-scale approach to ensure holistic identity preservation:

Biometric Identity Loss: The system may employ a pre-trained deep feature encoder (trained on facial recognition tasks) to extract embeddings from the generated output and the source target. The loss minimizes the cosine similarity distance between these vectors, ensuring that the biometric “signature” of the generated person matches the source, even if the lighting pixels are completely different.

Perceptual Texture Loss: To preserve skin texture and clothing material, the system may utilize a perceptual loss based on intermediate layers of a visual classification network. This ensures that the “style” of the identity is preserved at a texture level, preventing the over-smoothed look common in generative outputs.

Adversarial Patch Loss: To ensure the contact shadows and light wraps look realistic, a discriminator network may penalize the model if local patches of the image (specifically at the mask boundaries) are distinguishable from real photographs, forcing the model to learn the physics of light transport.

In a highly efficient embodiment, the identity preservation may be handled via Low-Rank Adaptation layers. During a “calibration” phase (potentially on the edge device), the system fine-tunes a small set of auxiliary weights (rank-decomposition matrices) on the specific source images of the user. These compact weight matrices encapsulate the specific “Identity Concept” of the user. During the inference phase, these specific weights are loaded into the generic diffusion model. This effectively specializes the generic model to only know how to generate that specific user, making it nearly impossible for the model to accidentally generate a generic person, thereby providing the highest tier of identity assurance.

In one embodiment, to enable the “Reference-Attention” inference capability, the training process is specifically configured to teach the model to utilize the semantic reference encoder. In this embodiment, the training data tuple (FIG. 16) is constructed such that the “Source Image” input to the reference encoder is a different image of the subject than the “Target Frame” being reconstructed (e.g., a profile view vs. a frontal view). The training system 81 freezes the weights of the reference encoder while updating the weights of the Cross-Attention layers within the main generative network. The loss function is calculated to penalize the model if it generates a generic person, forcing it to learn that the “Key” and “Value” vectors provided by the reference encoder contain the mandatory “blueprint” for the subject's identity. This effectively trains the model to perform “in-context learning,” extracting identity details from the source input rather than memorizing them in its weights.

In one embodiment, to train the “Spatial Adapter” branches responsible for interpreting the masking constraints, the system employs a Frozen Backbone training strategy. In this phase, the weights of the massive, pre-trained generative model (the “Base Model”) are locked to preserve its prior knowledge of lighting and physics. The training system 81 only updates the weights of the parallel adapter branches (the zero-convolution layers) and the injection connections. The training data comprises pairs of Input Mask, Ground Truth Image. By isolating the gradient updates to the adapter layers, the system ensures that the model learns a robust correlation between the spatial mask and the output structure without “catastrophic forgetting” of the Base Model's generative capabilities. This results in a modular architecture where the “Masking Capability” can be plugged into different Base Models without retraining the entire network.

In one embodiment, to support the “Stochastic Differential Editing” inference mode, where different regions are denoised at different strengths (t), the model is trained with Timestep-Dependent Loss Weighting. During training, the system randomly samples noise levels t from a continuous distribution ranging from “near-zero noise” (fine-tuning) to “pure Gaussian noise” (generation from scratch). The model is explicitly trained to perform denoising at all these stages. Crucially, the training curriculum emphasizes “resynthesis” tasks where the model receives a partially noisy latent and a conditioning mask, and must resolve the image. This ensures that during inference, when the system requests a low-noise edit for the face (to preserve identity) and a high-noise edit for the limbs (to articulate), the model is equally computed at resolving both requests within the same pass.

In one embodiment, the “Disentanglement via Low-Rank Adaptation” implies a specialized Runtime Calibration or Few-Shot Fine-Tuning phase. This is a rapid training step that occurs prior to the main inference. The system 81 receives a small set (e.g., 5-20 frames) of the specific user 1obj1 from the source video. It initializes a set of low-rank decomposition matrices (inserted into the attention layers of the model) and optimizes only these matrices to minimize the reconstruction error of the specific user. This process typically takes only seconds or minutes. The result is a user-specific “weight offset” file. During the main training of the base model, the system is taught to be “fine-tunable”, meaning the base weights are optimized to be a stable starting point that adapts quickly to these low-rank injections, ensuring the model is “malleable” enough to accept new identities on the fly.

In this description, numerous specific details are set forth. However, the embodiments/cases of the invention may be practiced without some of these specific details. In other instances, well-known hardware, materials, structures and techniques have not been shown in detail in order not to obscure the understanding of this description. In this description, references to “one embodiment” and “one case” mean that the feature being referred to may be included in at least one embodiment/case of the invention. Moreover, separate references to “one embodiment”, “some embodiments”, “one case”, or “some cases” in this description do not necessarily refer to the same embodiment/case. Illustrated embodiments/cases are not mutually exclusive, unless so stated and except as will be readily apparent to those of ordinary skill in the art. Thus, the invention may include any variety of combinations and/or integrations of the features of the embodiments/cases described herein. Also herein, flow diagrams illustrate non-limiting embodiment/case examples of the methods, and block diagrams illustrate non-limiting embodiment/case examples of the devices. Some operations in the flow diagrams may be described with reference to the embodiments/cases illustrated by the block diagrams. However, the methods of the flow diagrams could be performed by embodiments/cases of the invention other than those discussed with reference to the block diagrams, and embodiments/cases discussed with reference to the block diagrams could perform operations different from those discussed with reference to the flow diagrams. Moreover, although the flow diagrams may depict serial operations, certain embodiments/cases could perform certain operations in parallel and/or in different orders from those depicted. Moreover, the use of repeated reference numerals and/or letters in the text and/or drawings is for the purpose of simplicity and clarity and does not in itself dictate a relationship between the various embodiments/cases and/or configurations discussed. Furthermore, methods and mechanisms of the/embodiments/cases will sometimes be described in singular form for clarity. However, some embodiments/cases may include multiple iterations of a method or multiple instantiations of a mechanism unless noted otherwise. For example, when a controller or an interface are disclosed in an embodiment/case, the scope of the embodiment/case is intended to also cover the use of multiple controllers or interfaces.

Certain features of the embodiments/cases, which may have been, for clarity, described in the context of separate embodiments/cases, may also be provided in various combinations in a single embodiment/case. Conversely, various features of the embodiments/cases, which may have been, for brevity, described in the context of a single embodiment/case, may also be provided separately or in any suitable sub-combination. The embodiments/cases are not limited in their applications to the details of the order or sequence of steps of operation of methods, or to details of implementation of devices, set in the description, drawings, or examples. In addition, individual blocks illustrated in the figures may be functional in nature and do not necessarily correspond to discrete hardware elements. While the methods disclosed herein have been described and shown with reference to particular steps performed in a particular order, it is understood that these steps may be combined, sub-divided, or reordered to form an equivalent method without departing from the teachings of the embodiments/cases. Accordingly, unless specifically indicated herein, the order and grouping of the steps is not a limitation of the embodiments/cases. Embodiments/cases described in conjunction with specific examples are presented by way of example, and not limitation. Moreover, it is evident that many alternatives, modifications and variations will be apparent to those skilled in the art. Accordingly, it is intended to embrace all such alternatives, modifications and variations that fall within the spirit and scope of the appended claims and their equivalents.

At least some of the processes and/or steps disclosed herein may be realized as, or in conjunction with, a program, code, and/or executable instructions, to be executed by a computer, several computers, servers, logic circuits, etc. This includes, but is not limited to, any system, method, or apparatus disclosed herein.

Various processes or steps may be embodied as a non-transitory computer readable storage medium that stores the program, code, and/or executable instructions. This medium may include any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions.

The non-transitory computer readable medium or media may be transportable, such that the program or programs stored thereon may be loaded onto one or more different computers or other processors to implement various aspects described above. In some embodiments, the program, code, and/or executable instructions may be loaded electronically, e.g., via a network, into the non-transitory computer readable medium or media.

1. A method for generating an enhanced video sequence depicting a real-world object integrated into a synthetic environment, the method comprising:
receiving an initial composite video sequence, wherein frames of said initial composite video sequence depict representations of the real-world object integrated within corresponding depictions of the synthetic environment, and wherein said initial composite video sequence relates to an original source recording of the real-world object;
receiving object appearance information characterizing visual attributes of the real-world object, said object appearance information being derived from the appearance of the real-world object within the original source recording; and
processing the initial composite video sequence using a diffusion-based generative model to generate an enhanced composite video sequence, said processing comprising: guiding the diffusion-based generative model during generation of the enhanced composite video sequence utilizing information derived from both the initial composite video sequence and the received object appearance information;
wherein the generated enhanced composite video sequence exhibits visual attributes consistent with the received object appearance information, while demonstrating improved visual integration between the representations of the real-world object and the depictions of the synthetic environment compared to the initial composite video sequence.

2. The method of claim 1, wherein the initial composite video sequence is generated by:
tracking motion associated with the capture of the original source recording relative to the real-world object, thereby defining an initial camera motion trajectory;
extracting object representations corresponding to the real-world object from the original source recording;
placing said object representations within a synthetic 3D scene constituting the synthetic environment; and
rendering the synthetic 3D scene containing the placed object representations from viewpoints determined by the initial camera motion trajectory.

3. The method of claim 2, wherein the improved visual integration demonstrated by the generated enhanced composite video sequence is associated with a reduction of perceived visual inconsistencies arising from discrepancies between (i) viewpoints determined by the initial camera motion trajectory used for rendering the object representations within the initial composite video sequence, and (ii) effective viewpoints from which the real-world object was captured in the original source recording corresponding to said object representations;
said reduction of inconsistencies being achieved through adaptive modification of the visual appearance of the object representations by the diffusion-based generative model, while maintaining visual attributes consistent with the received object appearance information.

4. The method of claim 2, wherein the improved visual integration demonstrated by the generated enhanced composite video sequence is associated with an enhanced perceived fluidity of camera movement compared to the initial composite video sequence;
said enhanced perceived fluidity being achieved by the diffusion-based generative model, when guided by information from the initial composite video sequence and the received object appearance information, synthesizing frames for the enhanced composite video sequence that collectively depict a modified sequence of viewpoints corresponding to a camera motion trajectory with reduced noise or irregularities compared to the initial camera motion trajectory, while maintaining visual attributes consistent with the received object appearance information.

5. The method of claim 4, wherein the diffusion-based generative model, when synthesizing frames that collectively depict the modified sequence of viewpoints, is further guided by the initial camera motion trajectory.

6. The method of claim 1, wherein the improved visual integration is associated with an adaptive adjustment of contrast of the representations of the real-world object by the diffusion-based generative model to better match contrast characteristics of the depictions of the synthetic environment, while preserving visual attributes consistent with the received object appearance information.

7. The method of claim 1, wherein the improved visual integration is associated with an adaptive adjustment of brightness of the representations of the real-world object by the diffusion-based generative model to better match illumination levels of the depictions of the synthetic environment, while preserving visual attributes consistent with the received object appearance information.

8. The method of claim 1, wherein the improved visual integration is associated with an adaptive adjustment of color composition of the representations of the real-world object by the diffusion-based generative model to achieve greater color harmony with the depictions of the synthetic environment, while preserving visual attributes consistent with the received object appearance information.

9. The method of claim 1, wherein the improved visual integration is associated with a generation or modification of shadowing related to the representations of the real-world object by the diffusion-based generative model, such that said shadowing is more consistent with light sources within the depictions of the synthetic environment, while preserving visual attributes consistent with the received object appearance information.

10. The method of claim 1, wherein the improved visual integration is associated with a reduction or modification of glare or specular highlights on the representations of the real-world object by the diffusion-based generative model, to better align with reflective properties and light sources within the depictions of the synthetic environment, while preserving visual attributes consistent with the received object appearance information.

11. The method of claim 1, wherein the improved visual integration is associated with a generation or enhancement of contact shadows at an interface between the representations of the real-world object and surfaces within the depictions of the synthetic environment by the diffusion-based generative model, thereby improving a sense of grounding of the object, while preserving visual attributes consistent with the received object appearance information.

12. The method of claim 1, wherein the improved visual integration is associated with a generation or refinement of diffuse shadows cast by or upon the representations of the real-world object by the diffusion-based generative model, to more accurately reflect the interplay of light and occlusion within the depictions of the synthetic environment, while preserving visual attributes consistent with the received object appearance information.

13. The method of claim 1, wherein the real-world object is a human, and the improved visual integration is associated with an enhancement of perceived human-environment interactivity by the diffusion-based generative model, creating a more natural and contextually appropriate depiction of the human within the synthetic environment, while preserving visual attributes consistent with the received object appearance information; and wherein said guiding is further facilitated by applying varying degrees of permissible variation using a guidance mask corresponding to said degrees.

14. The method of claim 13, wherein the enhancement of perceived human-environment interactivity comprises an adaptive adjustment of the depicted human's gaze direction by the diffusion-based generative model, orienting the gaze towards a designated object or area of interest within the depictions of the synthetic environment.

15. The method of claim 13, wherein the enhancement of perceived human-environment interactivity comprises an adaptive modification of the depicted human's pose or subtle body language by the diffusion-based generative model, to suggest interaction with or reaction to elements within the depictions of the synthetic environment.

16. The method of claim 13, wherein the enhancement of perceived human-environment interactivity comprises a generation or modification of subtle environmental effects on the human representation, such as wind affecting hair or clothing, or splashes from virtual water, by the diffusion-based generative model, consistent with conditions depicted in the synthetic environment.

17. The method of claim 13, wherein the enhancement of perceived human-environment interactivity comprises an adjustment to the depiction of the human's hands or limbs by the diffusion-based generative model, to suggest interaction with, or plausible proximity to, objects or surfaces within the depictions of the synthetic environment.

18. The method of claim 1, wherein:
the real-world object is a human;
exhibiting visual attributes consistent with the received object appearance information comprises preserving the human identity of said human as depicted in the original source recording; and
preserving the human identity comprises at least one of: (i) maintaining recognizable facial features of the human, (ii) maintaining characteristic body shape and proportions of the human, (iii) maintaining recognizable skin tone and texture of the human, (iv) maintaining recognizable hairstyle and hair color of the human, (v) maintaining an appearance of clothing and accessories worn by the human as depicted in the original source recording, and (vi) maintaining characteristic gait or movement style of the human.

19. A system for generating an enhanced video sequence depicting a real-world object integrated into a synthetic environment, the system comprising:
a first input interface configured to receive an initial composite video sequence, wherein frames of said initial composite video sequence depict representations of the real-world object integrated within corresponding depictions of the synthetic environment, and wherein said initial composite video sequence relates to an original source recording of the real-world object;
a second input interface configured to receive object appearance attributes characterizing the real-world object, said object appearance attributes being derived from the original source recording;
a model storage configured to store a diffusion-based generative model;
at least one processor communicatively coupled to the first input interface, the second input interface, and the model storage, the at least one processor configured to:
access the diffusion-based generative model from the model storage; and
process the initial composite video sequence using the accessed diffusion-based generative model to generate an enhanced composite video sequence, wherein:
(i) said processing by the diffusion-based generative model is conditioned on both the content of the initial composite video sequence received via the first input interface and the object appearance attributes received via the second input interface to generate the enhanced composite video sequence, and
(ii) the generated enhanced composite video sequence, as a result of said conditioned processing, exhibits visual characteristics consistent with the received object appearance attributes, while demonstrating improved visual integration between the representations of the real-world object and the depictions of the synthetic environment compared to the initial composite video sequence; and
an output interface configured to provide the generated enhanced composite video sequence.

20. A method for training a diffusion-based generative model to enhance video sequences while preserving object identity, the method comprising:
for a plurality of training steps, utilizing a training data tuple comprising (i) an initial composite frame, (ii) object appearance information derived from an original source recording, and (iii) a corresponding target enhanced frame:
processing, using the diffusion-based generative model, the initial composite frame to generate a predicted frame, wherein said processing is guided by the object appearance information;
calculating a combined loss value based on:
a reconstruction loss measuring a difference between the predicted frame and the target enhanced frame, and
an identity loss measuring a difference between visual identity features of the object as depicted in the predicted frame and visual identity features derived from the object appearance information; and
updating weights of the diffusion-based generative model based on the combined loss value.
